(19) United States
(12) Patent Application Publication
(10) Pub. No.: US 2026/0007973 A1
(43) Pub. Date: Jan. 8, 2026

(54) VIRTUAL OBJECT CONTROL

(71) Applicant: Tencent Technology (Shenzhen) Company Limited, Shenzhen (CN)

(72) Inventor: Jiatian LI, Shenzhen (CN)

(73) Assignee: Tencent Technology (Shenzhen) Company Limited, Shenzhen, GD (CN)

(21) Appl. No.: 19/330,583

(22) Filed: Sep. 16, 2025

Related U.S. Application Data
(63) Continuation of application No. PCT/CN2024/099424, filed on Jun. 14, 2024.

(30) Foreign Application Priority Data
Aug. 23, 2023 (CN) 202311073164.2

(51) Int. Cl. A63F 13/56; A63F 13/537; A63F 13/58

(52) U.S. Cl. CPC A63F 13/56; A63F 13/537; A63F 13/58

(57) ABSTRACT

Some aspects of the disclosure provide a method of virtual object control. In some examples, a first virtual object in a devouring status is displayed in a virtual environment when the first virtual object meets a devouring condition, the devouring status is a status in which the first virtual object performs a devouring on one or more second virtual objects in the virtual environment. When the first virtual object is in a devouring completion state with the devouring being completed, the first virtual object with a devouring gain from the devouring is displayed in the virtual environment. In response to a control operation on a third virtual object, the third virtual object is controlled to attack the first virtual object with the devouring gain. Apparatus and non-transitory computer-readable storage medium counterpart embodiments are also contemplated.

### RELATED APPLICATIONS

The present application is a continuation of International Application No. PCT/CN2024/099424, filed on Jun. 14, 2024, which claims priority to Chinese Patent Application 202311073164.2, filed on Aug. 23, 2023. The entire disclosures of the prior applications are hereby incorporated by reference.

### FIELD OF THE TECHNOLOGY

Embodiments of this disclosure relate to the field of human-computer interaction technologies, including a virtual object control method and apparatus, a terminal, and a storage medium.

### BACKGROUND OF THE DISCLOSURE

In a confrontational game, a player may control a virtual object to confront another virtual object (for example, a monster), to implement territorial contention or resource plundering.

In a related technology, attack strength and a battle capability of a monster are both fixed values preset by a system before a confrontation. That is, the monster does not grow and change during the confrontation. Therefore, before the confrontation, a player only needs to be equipped with a strong enough team to dispatch the team to kill the monster.

However, the attack strength and the battle capability of the monster are set by using the fixed values in the foregoing manner, and a confrontation result is determined after the player is equipped with the team. During a battle, the player basically does not need to perform an operation or make a response, and only needs to watch an automatic battle and performance of the team. Consequently, the confrontation process lacks fun and variability.

### SUMMARY

Embodiments of this disclosure provide a virtual object control method and apparatus, a terminal, and a storage medium. Technical solutions are as follows.

Some aspects of the disclosure provide a method of virtual object control. In some examples, a first virtual object in a devouring status is displayed in a virtual environment when the first virtual object meets a devouring condition, the devouring status is a status in which the first virtual object performs a devouring on one or more second virtual objects in the virtual environment. When the first virtual object is in a devouring completion state with the devouring being completed, the first virtual object with a devouring gain from the devouring is displayed in the virtual environment. In response to a control operation on a third virtual object, the third virtual object is controlled to attack the first virtual object with the devouring gain.

Some aspects of the disclosure provide an information processing apparatus that includes processing circuitry configured to perform the method of virtual object control.

Some aspects of the disclosure also provide a non-transitory computer-readable storage medium storing instructions which when executed by at least one processor cause the at least one processor to perform the method of virtual object control.

According to one aspect, an embodiment of this disclosure provides a virtual object control method, the method being performed by a terminal, and the method including: displaying a first virtual object in a devouring status in a virtual environment when the first virtual object meets a devouring condition, the devouring status being a status in which the first virtual object devours a second virtual object in the virtual environment; displaying, in the virtual environment when the first virtual object is in a devouring completion state, the first virtual object that obtains a devouring gain; and controlling, in response to a control operation on a third virtual object, the third virtual object to attack the first virtual object that obtains the devouring gain.

According to another aspect, an embodiment of this disclosure provides a virtual object control apparatus, the apparatus including: a display module, configured to display a first virtual object in a devouring status in a virtual environment when the first virtual object meets a devouring condition, the devouring status being a status in which the first virtual object devours a second virtual object in the virtual environment; and the display module being further configured to display, in the virtual environment when the first virtual object is in a devouring completion state, the first virtual object that obtains a devouring gain; and a control module, configured to control, in response to a control operation on a third virtual object, the third virtual object to attack the first virtual object that obtains the devouring gain.

According to another aspect, an embodiment of this disclosure provides a terminal, the terminal including a processor and a memory, the memory having at least one computer instruction stored therein, and the at least one computer instruction being loaded and executed by the processor to implement the virtual object control method according to the foregoing aspect.

According to another aspect, an embodiment of this disclosure provides a computer-readable storage medium (e.g., non-transitory computer-readable storage medium), the computer-readable storage medium having at least one computer instruction stored therein, and the computer instruction being loaded and executed by a processor (an example of processing circuitry) to implement the virtual object control method according to the foregoing aspect.

According to another aspect, an embodiment of this disclosure provides a computer program product, the computer program product including a computer instruction, and the computer instruction being stored in a computer-readable storage medium; and a processor of a terminal reading the computer instruction from the computer-readable storage medium, and the processor executing the computer instruction, to cause the terminal to perform the virtual object control method according to the foregoing aspect.

In the embodiments of this disclosure, the devouring condition is set, and when the first virtual object meets the devouring condition, devouring may be initiated to the second virtual object, to obtain the corresponding devouring gain, thereby dynamically adjusting an object status of a virtual object during a confrontation, and improving variability and playability of the confrontation. In addition, a devouring and gain mechanism is set between virtual objects, so that virtual objects in a plurality of different states can be displayed during the confrontation by developing only a small quantity of virtual objects and the corresponding devouring and gain mechanism, thereby avoiding storage and loading pressure of presetting a plurality of virtual objects.

### BRIEF DESCRIPTION OF THE DRAWINGS

FIG. 1 is a block diagram of a structure of a computer system according to an embodiment of this disclosure.

FIG. 2 is a flowchart of a virtual object control method according to an embodiment of this disclosure.

FIG. 3 is a schematic diagram of devouring a second virtual object by a first virtual object in a first candidate devouring manner according to an embodiment of this disclosure.

FIG. 4 is a schematic diagram of changes in a devoured progress bar and changes in a prop energy bar according to an embodiment of this disclosure.

FIG. 5 is a schematic diagram of a plurality of third virtual objects applying a devouring prevention action to a second virtual object according to an embodiment of this disclosure.

FIG. 6 is a schematic diagram of whether a second virtual object and a third virtual object belong to or do not belong to the same camp according to an embodiment of this disclosure.

FIG. 7 is a schematic diagram of devouring a second virtual object by a first virtual object in a second candidate devouring manner according to an embodiment of this disclosure.

FIG. 8 is a schematic diagram of devouring a second virtual object by a first virtual object in a third candidate devouring manner and the second virtual object and a third virtual object belonging to different camps according to an embodiment of this disclosure.

FIG. 9 is a schematic diagram of devouring a second virtual object by a first virtual object in a third candidate devouring manner and the second virtual object and a third virtual object belonging to the same camp according to an embodiment of this disclosure.

FIG. 10 is a flowchart of determining a target devouring manner according to an embodiment of this disclosure.

FIG. 11 is a block diagram of a structure of a virtual object control apparatus according to an embodiment of this disclosure.

FIG. 12 is a schematic diagram of a structure of a terminal according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Virtual environment: a virtual environment displayed (or provided) when an application program runs on a terminal. The virtual environment may be a simulated environment of the real world, may be a semi-simulated and semi-fictional environment, or may be an entirely fictional environment. The virtual environment may be any one of a two-dimensional virtual environment, a 2.5-dimensional virtual environment, and a three-dimensional virtual environment. This is not limited in the embodiments of this disclosure.

In one embodiment, the virtual environment may provide a battle environment between virtual objects. For example, in a confrontation game, a virtual object controlled by a player battles against another virtual object (for example, a monster) in the virtual environment, the virtual object controlled by the player achieves an objective of survival in the virtual environment by attacking the monster, and when a life value of the virtual object controlled by the player in the virtual environment is zero, the life of the virtual object controlled by the player in the virtual environment ends. After the virtual object controlled by the player kills the monster, it is considered that the virtual object controlled by the player is a winner, and the virtual object controlled by the player may obtain a bonus such as a level increase, an attribute increase, or equipment. Each client may control one or more virtual objects in the virtual environment.

Virtual object: a movable object in the virtual environment.

In some embodiments, the virtual object is a movable object controlled by a player, such as a single role controlled by the player or a team controlled by the player.

In some embodiments, the virtual object is a movable object controlled by an application program, or is referred to as a non-player character (NPC). In some embodiments, the virtual object may be referred to as a “monster”, or may be referred to as a boss (a monster with relatively high winning difficulty and a relatively high winning bonus, and appearing at an end of a level or a key moment of a game plot).

The virtual object may be a virtual character, a virtual animal, a cartoon character, a virtual monster, a virtual robot, a virtual tank, a virtual plane, or the like. In one embodiment, the virtual object is a three-dimensional spatial model created based on a skeletal animation technology. Each virtual object has a shape and a volume in the virtual environment, and occupies some space in the virtual environment.

Devouring: a game operation type. A devouring party and a devoured party exist during the devouring. The devouring party is an NPC or a virtual object controlled by an another-end player, and the devoured party is a virtual object controlled by a local player or another NPC. For example, a boss may devour a virtual object controlled by a player, or may devour a common monster. The common monster may devour the virtual object controlled by the player, or may devour another common monster whose level is not higher than that of the common monster.

In some embodiments, when the devouring succeeds, the life of the devoured party in the virtual environment ends, the life of the devouring party in the virtual environment continues, an attribute, a level, a form, or other performance of the devouring party is improved, and an improvement degree is related to a quantity, an attribute, a level, a form, or other performance of the devoured party.

For example, when the common monster successfully devours five small monsters, a blood volume of the common monster is increased by 500 points; or when the common monster successfully devours ten small monsters, a blood volume of the common monster is increased by 1000 points. For example, when the boss successfully devours two common monsters, the boss repairs a damaged battle part or a new battle part grows (for example, more attack arms grow).

In some embodiments, there may be a plurality of different manners and types of devouring.

Devoured progress bar: configured for displaying a devoured progress of a devoured party. The devoured progress automatically increases with time. In one embodiment, a total length of the devoured progress bar is related to an attribute, a level, a form, or other performance of the devoured party. The devoured progress is related to an attribute, a level, a form, or other performance of a devouring party.

In some embodiments, when the devoured progress bar reaches a progress threshold, devouring succeeds. If the devoured progress bar does not reach a progress threshold, another virtual object different from the devouring party or the devoured party may perform a devouring prevention action, to prevent devouring from succeeding. For example, in a process in which a common monster devours a small monster, a virtual object controlled by a player may perform a devouring prevention action on the devoured party, to prevent the devouring from succeeding, thereby preventing the common monster from evolving into a higher-level monster.

Virtual prop: includes at least one of virtual equipment and a functional prop. For example, the virtual equipment is a prop that affects an activity status or a life value of another virtual object after being used by a virtual object. In one embodiment, the virtual equipment includes a cold weapon, artillery, an armored fighting vehicle, or the like. Different virtual equipment corresponds to different equipment attributes, including attack damage, an attack range, an attack rate, and the like.

In some embodiments, the virtual equipment includes a devouring prop, and the devouring prop is used by a devouring party to devour a devoured party. In one embodiment, the devouring party transmits the devouring prop to the other virtual object, to devour the other virtual object. In one embodiment, the devouring prop has a prop attribute, for example, a prop energy value. A higher prop energy value indicates greater strength of devouring the devoured party. Therefore, when a virtual object controlled by a player performs a devouring prevention action on the devoured party, the prop energy value of the devouring prop is reduced.

The method provided in this disclosure may be applied to an application program having a virtual environment and a virtual object. For example, an application program that supports a virtual environment is an application program in which a user may control a virtual object to move within the virtual environment and to attack another virtual object. For example, the method provided in this disclosure may be applied to: any one of a virtual reality (VR) program, an augmented reality (AR) program, a three-dimensional map program, a virtual reality game, an augmented reality game, a first-person shooting (FPS) game, a third-person shooting (TPS) game, a multiplayer online battle arena (MOBA) game, and a simulation game (SLG).

For example, a game in the virtual environment includes maps of one or more game worlds. The virtual environment in the game simulates real-world scenes. A user may control a virtual object in the game to execute actions such as walking, running, jumping, shooting, fighting, driving, and attacking another virtual object with virtual equipment in the virtual environment, thereby implementing relatively strong interactivity. In one embodiment, the game can further support a plurality of users in forming a team online to play the game.

In some embodiments, the foregoing application programs may be programs such as a shooting game, a racing game, a role-playing game, an adventure game, a sandbox game, and a battle arena game. The application program may support at least one of a Windows operating system, an Apple operating system, an Android operating system, an iPhone operation system (IOS), and a LINUX operating system. In one embodiment, the application programs of the different operating systems may be interconnected.

Refer to FIG. 1. FIG. 1 is a block diagram of a structure of a computer system according to an embodiment of this disclosure. The computer system includes: a terminal 110 and a server 120.

An application program supporting a virtual environment is installed and run on the terminal 110. The terminal 110 may be a mobile terminal such as a smartphone, a tablet computer, a laptop portable notebook computer, or an in-vehicle terminal, or may be a terminal such as a desktop computer or a projection computer. An example in which the terminal 110 is a smartphone is used for description in this specification. However, this is not limited.

A player may use the terminal 110 to control a virtual object located in the virtual environment, including at least one of adjusting a body posture of the virtual object, walking, running, jumping, attacking another virtual object, picking up virtual equipment, wearing the virtual equipment, switching currently used virtual equipment, and executing a devouring prevention action.

The terminal 110 is connected to the server 120 through a wireless network or a wired network.

The server 120 includes at least one of one server, a plurality of servers, a cloud computing platform, and a virtualization center. For example, the server 120 includes a processor 121, a battle service module 122, and a user-oriented input/output interface (I/O interface) 123. The processor 121 is configured to load instructions stored in the server 120 and process data in the battle service module 122. The battle service module 122 is configured to implement a battle process (including a devouring process and the like) between virtual objects. The user-oriented I/O interface 123 is configured to establish communication with the terminal 110 through a wireless network or a wired network for a data exchange.

In some embodiments, a virtual object control method in an embodiment of this disclosure may be performed by the terminal 110. For example, the terminal 110 may display a virtual object in a virtual environment, and control the virtual object to execute a devouring prevention action, or control the virtual object to attack another virtual object. In some embodiments, the server 120 may alternatively be configured to control the virtual object. For example, the server 120 may control, based on an attribute, a level, a form, or other performance of a monster, the monster to devour another small monster. For example, the server 120 may determine a devouring occasion, a devouring manner, and a quantity of devoured parties, and transmit a devouring-related instruction to the terminal 110. The terminal 110 displays, in the virtual environment based on the instruction, a picture corresponding to a devouring process. In some embodiments, the virtual object control method in the embodiment of this disclosure may be jointly performed by the terminal 110 and the server 120.

The foregoing embodiment merely describes a general architecture of an implementation environment, and the system may further include more or fewer components, or some components may be combined. This is not limited in this embodiment.

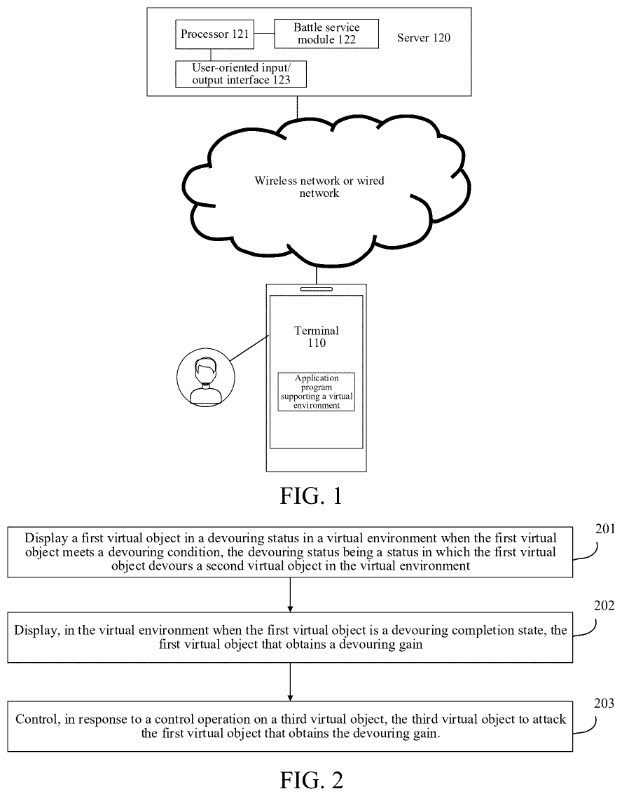

Refer to FIG. 2. FIG. 2 is a flowchart of a virtual object control method according to an embodiment of this disclosure. This embodiment is described by using an example in which the method is performed by a terminal. The method includes the following operations.

Operation 201. Display a first virtual object in a devouring status in a virtual environment when the first virtual object meets a devouring condition, the devouring status being a status in which the first virtual object devours a second virtual object in the virtual environment.

In some embodiments, the first virtual object is a non-player character that is controlled by an application program and that may initiate devouring to another virtual object. During the devouring, the first virtual object is a devouring party.

In some other embodiments, the first virtual object may alternatively be a virtual object that is controlled by an another-end player and that may initiate devouring to another virtual object. For example, when the first virtual object is a role controlled by the other-end game player, the role may devour a role controlled by a local player.

In one embodiment, the first virtual object may be referred to as a “monster”, or may be referred to as a boss (a monster with relatively high winning difficulty and a relatively high winning bonus, and appearing at an end of a level or a key moment of a game plot). In one embodiment, the first virtual object is a virtual character, a virtual animal, a virtual monster, a cartoon character, a virtual robot, or the like.

The devouring condition is a condition under which the first virtual object initiates devouring to another virtual object. In one embodiment, the devouring condition may be related to an object status of a virtual object, or may be related to a confrontation status. In some embodiments, the devouring condition may be set and determined by the terminal or a server.

In one embodiment, the devouring condition is that an attribute value of the first virtual object reaches a devouring trigger threshold. For example, the devouring condition may be that attack force of a monster reaches 500 points, or that an attack speed reaches 200 points.

In one embodiment, the devouring condition is that confrontation duration between a virtual object controlled by a player and the first virtual object reaches a duration threshold. For example, the devouring condition may be that the confrontation duration reaches 5 minutes.

In one embodiment, the devouring condition may further be determined based on a battle situation of the virtual object controlled by the player. For example, the devouring condition may be that a quantity of virtual objects defeated by the virtual object controlled by the player reaches a quantity threshold.

The second virtual object is a devoured party during the devouring.

In one embodiment, the second virtual object is a virtual object controlled by a player. For example, the second virtual object may be a single role controlled by the player, or a team controlled by the player.

In one embodiment, the second virtual object is another non-player character different from the first virtual object in the virtual environment. For example, the second virtual object may be another monster different from the first virtual object.

In some embodiments, when a level of the second virtual object is not greater than a level of the first virtual object, the first virtual object may initiate the devouring to the second virtual object. For example, if the first virtual object is a monster whose level is level 8, the second virtual object that may be devoured by the monster is another monster whose level is less than or equal to level 8.

In some embodiments, when the devouring succeeds, the life of the devoured party (the second virtual object) in the virtual environment ends, the life of the devouring party (the first virtual object) in the virtual environment continues, an attribute, a level, a form, or other performance of the devouring party is improved, and an improvement degree is related to a quantity, an attribute, a level, a form, or other performance of the devoured party.

The devouring status is a status in which the first virtual object devours the second virtual object in the virtual environment.

In some embodiments, the devouring status is determined based on a devouring manner corresponding to the first virtual object.

For example, if the first virtual object may devour the second virtual object in different candidate devouring manners, the first virtual object may have corresponding different devouring statuses. For example, when a monster transmits a devouring prop to the second virtual object by using a splitting action, a devouring status of the monster is a status that the monster may support movement and an active attack and is immune to (e.g., not subject) an attack initiated by another virtual object. When the monster devours the second virtual object by using a calling action, the devouring status of the monster is a status that the monster does not support movement or an active attack and is immune to the attack initiated by the other virtual object.

In some embodiments, the devouring status may further be determined based on a role type of the first virtual object. For example, when the first virtual object is a common monster, the devouring status may be a status of supporting movement and an active attack. When the first virtual object is a boss, the devouring status may be a status of supporting movement, an active attack, and freezing of the virtual object controlled by the player.

In an example implementation, during a confrontation, the terminal detects, in real time, the virtual object that is in the virtual environment and that meets the devouring condition, and when determining that the first virtual object meets the devouring condition, determines, based on an object attribute of the first virtual object and an object attribute of another virtual object, the devoured party (the second virtual object) that conforms to the first virtual object, to control the first virtual object to devour the second virtual object.

Operation 202. Display, in the virtual environment when the first virtual object is in a devouring completion state, the first virtual object that obtains a devouring gain.

The devouring completion state is a state in which the first virtual object completes devouring the second virtual object. After the devouring is completed, the first virtual object obtains the devouring gain.

In one embodiment, the devouring gain includes a gain of an attribute, a level, a form, or other performance of the first virtual object.

In some embodiments, the devouring gain is related to a quantity, an attribute, a level, a form, or other performance of the second virtual object (the devoured party). For example, when the common monster successfully devours five small monsters, a blood volume of the common monster is increased by 500 points; or when the common monster successfully devours ten small monsters, a blood volume of the common monster is increased by 1000 points. For example, when the boss successfully devours two common monsters, the boss repairs a damaged battle part or a new battle part grows (for example, more attack arms grow).

In one embodiment, after the devouring is completed, the terminal displays, in the virtual environment, the first virtual object that obtains the devouring gain. A display manner may include displaying a blood volume slot, an attribute bar, a form change, an improvement effect of other performance, or the like corresponding to the first virtual object that obtains the devouring gain.

In an example implementation, when a third virtual object does not successfully prevent the devouring, the terminal collects statistics on the gain generated by the first virtual object during the devouring, and displays the first virtual object that obtains the devouring gain.

Operation 203. Control, in response to a control operation on the third virtual object, the third virtual object to attack the first virtual object that obtains the devouring gain.

The control operation is an operation performed by the player on the third virtual object. In one embodiment, the control operation includes operations such as controlling walking, running, jumping, attacking, squatting, and equipping a prop. In one embodiment, the control operation may be implemented in a manner such as wheel control, gesture control, or a voice instruction.

In some embodiments, when the third virtual object does not successfully prevent the devouring, after the first virtual object obtains the devouring gain, the player may still apply the control operation to the third virtual object, to control the third virtual object to attack the first virtual object that obtains the devouring gain.

For example, before the first virtual object obtains the devouring gain, a blood volume of the first virtual object is 500 points, and the devouring gain obtained by the first virtual object by devouring the second virtual object is a blood volume gain of 1000 points. In this case, after obtaining the devouring gain, the first virtual object has a blood volume of 1500 points, so that when receiving the control operation by the player on the third virtual object, the terminal can control the third virtual object to attack the first virtual object having a blood volume of 1500 points.

To sum up, in this embodiment of this disclosure, the devouring condition is set, and when the first virtual object meets the devouring condition, devouring may be initiated to the second virtual object, to obtain the corresponding devouring gain, thereby dynamically adjusting an object status of a virtual object during a confrontation, and improving variability and playability of the confrontation.

In addition, a devouring and gain mechanism is set between virtual objects, so that virtual objects in a plurality of different states can be displayed during the confrontation by developing only a small quantity of virtual objects and the corresponding devouring and gain mechanism, thereby avoiding storage and loading pressure of presetting a plurality of virtual objects.

In some embodiments, to implement an interaction between the player and the devouring process during the devouring of the first virtual object, the terminal may respond to the control operation by the player on the third virtual object, to control the third virtual object to perform a devouring prevention action.

In some embodiments, the terminal controls, in the devouring status in response to the control operation on the third virtual object, the third virtual object to execute a devouring prevention action, the devouring prevention action acting on at least one of the first virtual object and second virtual object.

The third virtual object is a virtual object controlled by the player. For example, the third virtual object may be a single role controlled by the player, or a team controlled by the player.

The control operation is an operation performed by the player on the third virtual object. In one embodiment, the control operation includes operations such as controlling walking, running, jumping, attacking, squatting, and equipping a prop. In one embodiment, the control operation may be implemented in a manner such as wheel control, gesture control, or a voice instruction.

The devouring prevention action is executed by the third virtual object, and acts on at least one of the first virtual object and the second virtual object, to prevent the first virtual object from devouring the second virtual object.

In one embodiment, the devouring prevention action is an action of attacking the first virtual object by the third virtual object, or an action of attacking, by the third virtual object, a devouring prop applied to the second virtual object.

In an example implementation, when receiving the control operation by the player on the third virtual object, the terminal controls the third virtual object to execute the devouring prevention action, for example, controls the third virtual object to attack the first virtual object, so that when the third virtual object defeats the first virtual object, it is determined that the devouring is successfully prevented. When the third virtual object does not defeat the first virtual object, it is determined that the devouring is not successfully prevented.

In the foregoing embodiment, during the devouring, the third virtual object is controlled to execute the devouring prevention action, thereby improving an interaction between the player and the devouring process, further enriching a confrontation possibility, and improving an uncertainty and fun of the confrontation.

In some embodiments, to optimize a confrontation effect, the first virtual object may devour the second virtual object in a plurality of devouring manners. A specific devouring manner to be used may be related to a status (such as a role, an attribute, a level, a blood volume, a skill, a form, or other performance) of the first virtual object, or may be related to a status (such as a quantity and a level) of the second virtual object.

In one embodiment, the first virtual object may devour the second virtual object in three candidate devouring manners, and the candidate devouring manners are candidate manners that can be configured for devouring the second virtual object by the first virtual object. The three candidate devouring manners are respectively a first candidate devouring manner (splitting devouring), a second candidate devouring manner (calling devouring), and a third candidate devouring manner (fusion devouring).

Three candidate devouring manners are respectively described below by using embodiments.

### First Candidate Devouring Manner

In some embodiments, a first virtual object devours a second virtual object in the first candidate devouring manner. The first candidate devouring manner may alternatively be referred to as “splitting devouring”.

When the first candidate devouring manner is used, a devouring process may include the following operations:

Operation 1. Display, in a virtual environment when the first virtual object uses the first candidate devouring manner, the first virtual object executing a splitting action, the splitting action being an action of transmitting a devouring prop to the second virtual object, and the devouring prop being configured for devouring the second virtual object.

In an example implementation, when the first virtual object meets a devouring condition, a terminal may control the first virtual object to transmits the devouring prop to the second virtual object, to devour the second virtual object. Further, when the devouring prop hits the second virtual object, the terminal displays the second virtual object devoured by the devouring prop.

The devouring prop may be generated through splitting of the first virtual object by controlling the first virtual object to execute the splitting action. In one embodiment, the devouring prop may be a liquid, for example, virtual metal in a liquid state; may be a gas, for example, a virtual poison gas split and vented by the first virtual object; or may be a solid or another prop that may devour the second virtual object. This is not limited in this embodiment of this disclosure. In addition, a prop shape of the devouring prop is not limited in this embodiment of this disclosure.

In one embodiment, that the devouring prop devours the second virtual object may be represented as that the devouring prop is attached to the second virtual object, and an attachment area continuously increases, that the devouring prop gradually wraps the second virtual object, that the devouring prop invades the second virtual object and spreads in the second virtual object, or the like.

In one embodiment, the first virtual object may transmit one or more devouring props when executing the splitting action. When the splitting action is executed to generate a plurality of devouring props, the terminal may control the first virtual object to respectively transmit the devouring props to a plurality of second virtual objects, or may control the first virtual object to simultaneously transmit the plurality of devouring props to one second virtual object. That is, the devouring prop and the second virtual object may be in a one-to-one correspondence, a many-to-one correspondence, or a many-to-many correspondence.

In one embodiment, an object level of the first virtual object is greater than an object level of the second virtual object. In an example implementation, when controlling the first virtual object to execute the splitting action, the terminal may first determine whether a second virtual object that conforms to a level condition exists around the first virtual object, so that when a second virtual object whose level is less than that of the first virtual object exists, the terminal transmits, to the second virtual object, the devouring prop released by the first virtual object.

In one embodiment, to reduce devouring difficulty, in a process in which the devouring prop devours the second virtual object, the second virtual object cannot move in the virtual environment, and cannot attack another virtual object.

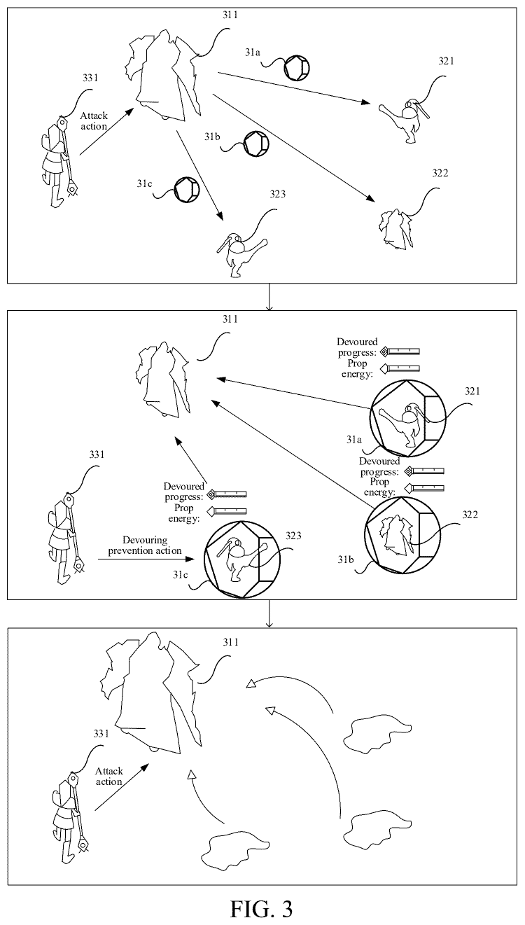

Refer to FIG. 3. FIG. 3 is a schematic diagram of devouring a second virtual object by a first virtual object in a first candidate devouring manner according to an embodiment of this disclosure.

As shown in FIG. 3, a terminal displays a first virtual object 311 in a virtual environment, and the first virtual object 311 may devour second virtual objects 321, 322, and 323 in the first candidate devouring manner.

When the first virtual object 311 meets a devouring condition, the terminal controls the first virtual object 311 to execute a splitting action. The splitting action is that the first virtual object 311 respectively transmits a devouring prop 31a to the second virtual object 321, a devouring prop 31b to the second virtual object 322, and a devouring prop 31c to the second virtual object 323.

When the devouring prop 31a hits the second virtual object 321, a form of the devouring prop 31a becomes large to wrap the second virtual object 321. When the devouring prop 31b hits the second virtual object 322, a form of the devouring prop 31b becomes large to wrap the second virtual object 322. When the devouring prop 31c hits the second virtual object 323, a form of the devouring prop 31c becomes large to wrap the second virtual object 323.

Operation 2. Display a devoured progress bar and a prop energy bar of the devouring prop, the devoured progress bar being configured for displaying a devoured progress of the second virtual object, the devoured progress automatically increasing with time, and the prop energy bar being configured for displaying a prop energy value of the devouring prop.

In an example implementation, to display the devoured progress of the second virtual object to a player in real time, the terminal may display the devoured progress bar and the prop energy bar of the devouring prop in a confrontation interface. In one embodiment, the terminal may display the devoured progress bar and the prop energy bar of the devouring prop in a region, for example, on a peripheral side of the second virtual object or at a top portion of the confrontation interface.

The devoured progress bar is configured for displaying the devoured progress of the second virtual object, and the devoured progress automatically increases with time. That is, after the devouring prop hits the second virtual object, as the devouring prop gradually devours the second virtual object, the devoured progress indicated by the devoured progress bar gradually increases.

The prop energy bar is configured for displaying the prop energy value of the devouring prop. The prop energy value corresponds to a prop energy threshold. The prop energy threshold is configured for indicating prop effectiveness of the devouring prop. When the prop energy value is less than the prop energy threshold, it indicates that the first virtual object fails to devour the second virtual object. For example, when the prop energy value is greater than zero, it indicates that the devouring prop can effectively devour the second virtual object. When the prop energy value is zero, it indicates that the devouring prop fails.

In one embodiment, the prop energy value is related to an object attribute of the second virtual object, and the prop energy value is affected by an attack by the third virtual object. In one embodiment, the player may control the third virtual object to attack the devouring prop, to reduce the prop energy value of the devouring prop.

Operation 3. When the execution of the splitting action is completed, the terminal displays the first virtual object in a first form, the first virtual object in the first form supporting movement and an active attack, and being not immune to an attack initiated by another virtual object.

In one embodiment, the first form is a state that the first virtual object has when the first virtual object devours the second virtual object in the first candidate devouring manner. The first virtual object in the first form supports the movement and the active attack, and is not immune to (e.g., subject to) the attack initiated by the other virtual object. That is, the first virtual object in the first form may perform operations such as free walking, running, jumping, squatting, equipping a prop, and launching an attack, and needs to be attacked by the other virtual object.

In one embodiment, the first virtual object in the first form is different from the first virtual object that is in a standard form and that exists before the splitting action is executed. For example, a form size of the first virtual object changes, or a visual effect of another type changes. For example, the first virtual object in the first form has a relatively small body shape.

As shown in FIG. 3, after the first virtual object 311 transmits the devouring props to the second virtual objects 321, 322, and 323, the first form of the first virtual object is a form obtained after the body shape becomes small. In addition, the first virtual object 311 in the first form supports the movement and the active attack. For example, the first virtual object 311 may move in a direction of the third virtual object 331, and attack the third virtual object 331. In the first form, the first virtual object 311 is not immune to the attack initiated by the other virtual object. In other words, the other virtual object may initiate the attack to the first virtual object 311.

Operation 4. Control, in the devouring status in response to the control operation on the third virtual object, the third virtual object to execute a devouring prevention action.

Operation 5. Update, when the devouring prevention action acts on the second virtual object, the prop energy value displayed by the prop energy bar, the devouring prevention action being configured for reducing the prop energy value of the devouring prop.

In one embodiment, that the devouring prevention action acts on the second virtual object may be an attack action on the second virtual object, or may be an attack action on the devouring prop applied to the second virtual object.

In one embodiment, the player may control, in a manner, for example, through mouse control or keyboard control, the third virtual object to apply the devouring prevention action to the second virtual object.

In an example implementation, when the third virtual object is controlled to apply the devouring prevention action to the second virtual object, the terminal updates and displays the prop energy value displayed by the prop energy bar, and the prop energy value displayed by the prop energy bar gradually decreases with attack duration.

In one embodiment, to prevent the first virtual object from devouring the second virtual object by using the devouring prop, the player may control the third virtual object to execute the devouring prevention action on the devouring prop, to reduce the prop energy value of the devouring prop, so that when the prop energy value of the devouring prop is less than the prop energy threshold, the first virtual object fails to devour the second virtual object.

In one embodiment, a decrease speed of the prop energy value may be in a positive correlation with an attack attribute (such as an attack speed, attack strength, or attack duration) of the third virtual object. For example, higher strength of the third virtual object attacking the devouring prop indicates a higher decrease speed of the prop energy value.

In one embodiment, the decrease speed of the prop energy value may further be in a negative correlation with a defense attribute (such as a defense equipment level or defense strength) of the first virtual object. For example, a higher defense equipment level of the first virtual object indicates a lower decrease speed of the prop energy value.

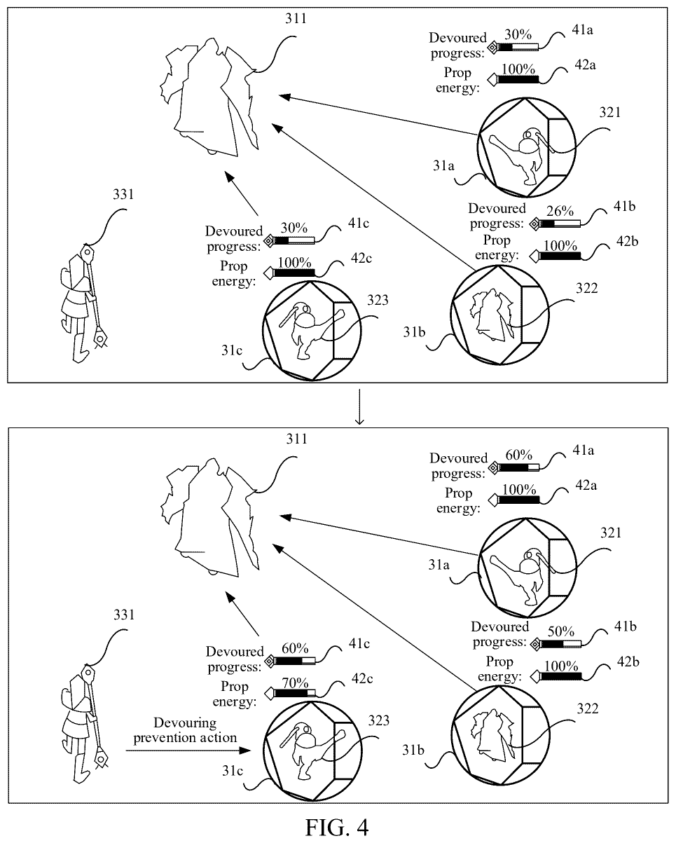

Refer to FIG. 4. FIG. 4 is a schematic diagram of changes in a devoured progress bar and changes in a prop energy bar according to an embodiment of this disclosure.

As shown in FIG. 4, in a process in which a first virtual object 311 devours second virtual objects 321, 322, and 323, a terminal displays, on a peripheral side of the second virtual object 321, a devoured progress bar 41a and a prop energy bar 42a that correspond to a devouring prop 31a, displays, on a peripheral side of the second virtual object 322, a devoured progress bar 41b and a prop energy bar 42b that correspond to a devouring prop 31b, and displays, on a peripheral side of the second virtual object 323, a devoured progress bar 41c and a prop energy bar 42c that correspond to a devouring prop 31c.

At a moment, devoured progresses of the second virtual objects 321, 322, and 323 are respectively 30%, 26%, and 30%. Before the moment, a third virtual object 331 controlled by a player does not execute a devouring prevention action. Therefore, all prop energy values of the prop energy bars corresponding to the devouring props 31a, 31b, and 31c are 100%.

At another moment after the moment, as time passes by, progresses of the first virtual object 311 devouring the second virtual objects 321, 322, and 323 increase, and the devoured progresses of the second virtual objects 321, 322, and 323 respectively increase to 60%, 50%, and 60%. Before the moment, the third virtual object 331 controlled by the player executes the devouring prevention action on the devouring prop 31c corresponding to the second virtual object 323. Therefore, the prop energy value of the prop energy bar corresponding to the devouring prop 31c decreases from 100% to 70%.

In some other embodiments, the devouring prevention action executed by the third virtual object may further act on the first virtual object.

In one embodiment, when the devouring prevention action acts on the first virtual object, the prop energy value corresponding to the devouring prop is related to a defense attribute (such as a defense equipment level or defense strength) of the first virtual object. For example, a decrease speed of the prop energy value is in a negative correlation with the defense attribute of the first virtual object. A higher defense equipment level of the first virtual object indicates a lower decrease speed of the prop energy value.

In one embodiment, in a process in which the first virtual object devours the second virtual object, one or more third virtual objects may execute the devouring prevention action on one or more second virtual objects, or one or more third virtual objects may execute the devouring prevention action on the first virtual object.

The one or more third virtual objects may be third virtual objects controlled by a user of the same terminal, or may be third virtual objects that are controlled by a plurality of terminals and that belong to the same battle team.

In one embodiment, a decrease speed of the prop energy value of the prop energy bar is in a negative correlation with a quantity of third virtual objects that execute the devouring prevention action. A larger quantity of third virtual objects that execute the devouring prevention action indicates a higher decrease speed of the prop energy value.

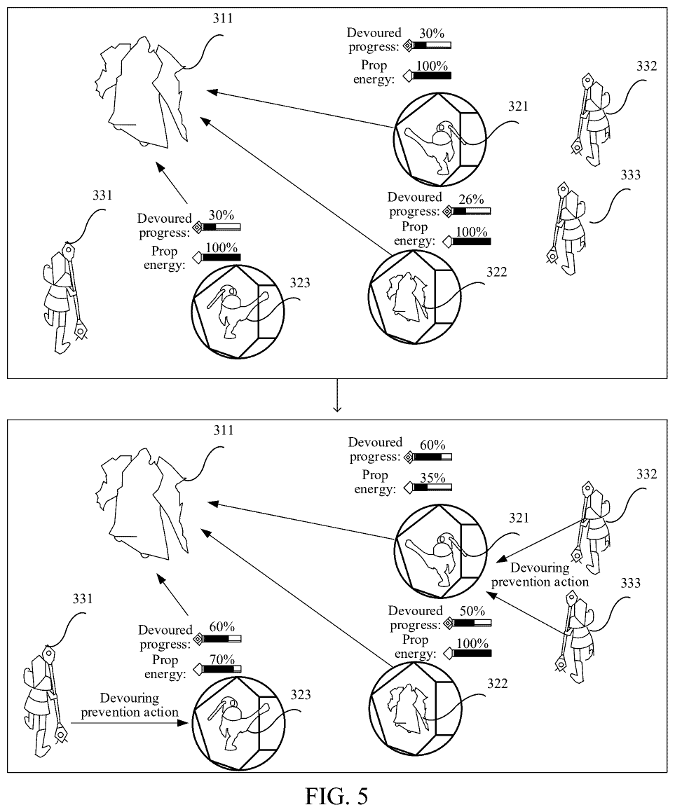

Refer to FIG. 5. FIG. 5 is a schematic diagram of a plurality of third virtual objects applying a devouring prevention action to a second virtual object according to an embodiment of this disclosure.

As shown in FIG. 5, in a process in which a first virtual object 311 devours second virtual objects 321, 322, and 323, devoured progresses of the second virtual objects 321, 322, and 323 are respectively 30%, 26%, and 30%. Before the moment, third virtual objects 331, 332, and 333 controlled by a player do not execute the devouring prevention action. Therefore, all prop energy values of prop energy bars corresponding to devouring props of the second virtual objects 321, 322, and 323 are 100%.

The third virtual object 331 may be a third virtual object controlled by a first terminal, the third virtual objects 332 and 333 may be third virtual objects respectively controlled by a second terminal and a third terminal, and the third virtual objects 331, 332, and 333 belong to the same camp.

At another moment after the moment, as time passes by, progresses of the first virtual object 311 devouring the second virtual objects 321, 322, and 323 increase, and the devoured progresses of the second virtual objects 321, 322, and 323 respectively increase to 60%, 50%, and 60%. Before the moment, the third virtual object 331 executes the devouring prevention action on the devouring prop corresponding to the second virtual object 323. Therefore, the prop energy value of the prop energy bar corresponding to the devouring prop decreases from 100% to 70%. The third virtual objects 332 and 333 jointly execute the devouring prevention action on the devouring prop corresponding to the second virtual object 321. Therefore, the prop energy value of the prop energy bar corresponding to the devouring prop decreases from 100% to 35%.

Operation 6. When the prop energy value displayed by the prop energy bar is greater than an energy threshold, and the devoured progress displayed by the devoured progress bar reaches a progress threshold, display the second virtual object switched to a fourth form, the fourth form being configured for representing that the second virtual object is devoured.

In an example implementation, with the execution of the devouring action, when the devoured progress displayed by the devoured progress bar reaches the progress threshold, and the prop energy value displayed by the prop energy bar is greater than the energy threshold, the terminal may display, in the virtual environment, the second virtual object switched to the fourth form, where the fourth form represents that the second virtual object is devoured.

In one embodiment, the energy threshold and the progress threshold may be preset values. For example, the energy threshold is 0.01%, and the progress threshold is 99.9%.

The fourth form is a form that the second virtual object has after the second virtual object is devoured. The second virtual object in the fourth form is different from a virtual object in a standard form. For example, as shown in FIG. 3, when the prop energy value of the devouring prop applied to the second virtual object is greater than 0.01%, and the devoured progress reaches 99.9%, the second virtual object in the fourth form may be converted into a liquefied metal layer.

In one embodiment, the terminal may further display a dynamic effect of the second virtual object in the fourth form. For example, after being converted into the liquefied metal layer, the second virtual object gradually infiltrates into the virtual environment with the dynamic effect until the second virtual object disappears.

In some embodiments, during the devouring, when the player controls the third virtual object to execute the devouring prevention action on the devouring prop, when attack strength of the third virtual object is relatively high, the prop energy value of the devouring prop may decrease to be less than the energy threshold before the devoured progress bar reaches the progress threshold. In this case, the devouring prevention action by the third virtual object may successfully prevent the first virtual object from devouring the second virtual object.

In an example scenario, the second virtual object and the third virtual object may belong to the same camp (for example, both are roles in a battle team controlled by the player). In another possible scenario, the second virtual object and the third virtual object may belong to different camps (for example, the second virtual object is a small monster, and the third virtual object is a role controlled by the player).

In an example implementation, when the second virtual object and the third virtual object belong to the same camp, the third virtual object executes the devouring prevention action not only to prevent the first virtual object from successfully devouring, but also to rescue the second virtual object in a devoured status. That is, the player controls the third virtual object to execute the devouring prevention action, and before the devoured progress reaches the progress threshold, the prop energy value decreases to be less than the energy threshold, so that devouring prevention can be implemented, and the devoured second virtual object is rescued. Therefore, when the devoured progress displayed by the devoured progress bar does not reach the progress threshold, the prop energy value displayed by the prop energy bar is less than the energy threshold, and the second virtual object and the third virtual object belong to the same camp, the terminal may display the second virtual object with reduced energy.

In one embodiment, the energy includes, but is not limited to, a blood volume, a level, an attribute, or performance in another form of the second virtual object, and an energy reduction quantity of the second virtual object is in a positive correlation with the devoured progress. For example, at a moment at which the second virtual object is successfully rescued, a higher devoured progress indicates a larger energy reduction quantity of the second virtual object.

In another possible implementation, when the second virtual object and the third virtual object belong to different camps, the third virtual object executes the devouring prevention action only to prevent the first virtual object from successfully devouring, without rescuing the second virtual object in the devoured status. That is, the player controls the third virtual object to execute the devouring prevention action, and before the devoured progress reaches the progress threshold, the prop energy value decreases to be less than the energy threshold, so that devouring prevention can be implemented, and the devoured second virtual object does not need to be rescued. Therefore, when the devoured progress displayed by the devoured progress bar does not reach the progress threshold, the prop energy value displayed by the prop energy bar is less than the energy threshold, and the second virtual object and the third virtual object belong to different camps, the terminal may stop displaying the second virtual object in the virtual environment.

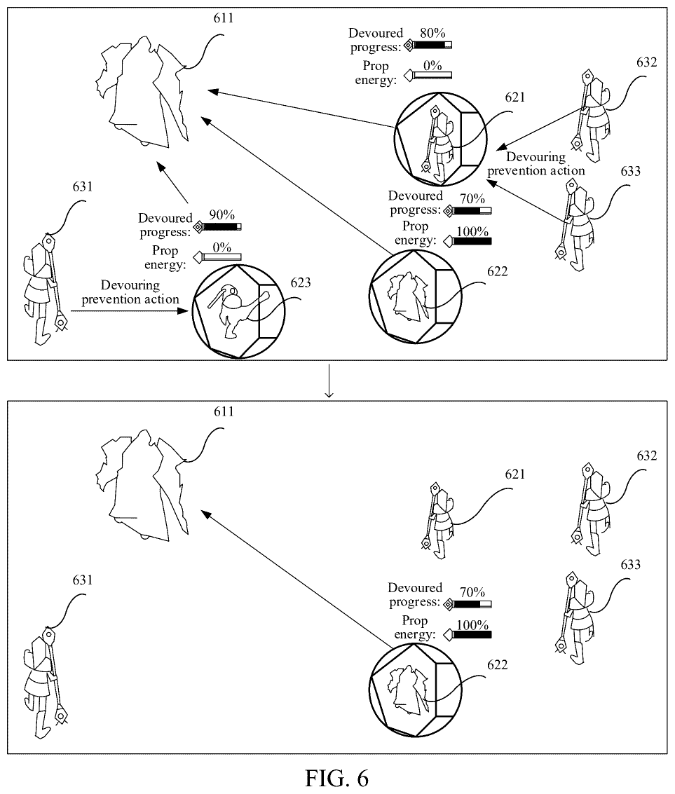

Refer to FIG. 6. FIG. 6 is a schematic diagram of whether a second virtual object and a third virtual object belong to or do not belong to the same camp according to an embodiment of this disclosure.

As shown in FIG. 6, in a process in which a first virtual object 611 devours second virtual objects 621, 622, and 623, a third virtual object executes a devouring prevention action on a devouring prop corresponding to the second virtual object 623, and third virtual objects 632 and 633 execute the devouring prevention action on a devouring prop corresponding to the second virtual object 621.

The second virtual object 621, a third virtual object 631, and the third virtual objects 632 and 633 belong to the same camp, and are virtual objects controlled by a player. The second virtual objects 622 and 623 and the third virtual object belong to different camps, and the second virtual objects 622 and 623 are small monsters.

For the second virtual object 621, when a devoured progress displayed by a devoured progress bar is less than 0.01% and a prop energy value displayed by a prop energy bar is less than 99.9%, it indicates that the second virtual object 621 is successfully rescued by the third virtual objects 632 and 633 in the same camp, thereby avoiding being devoured by the first virtual object 611. Therefore, a terminal may display, in a virtual environment, the second virtual object 621 with reduced energy, to indicate that the second virtual object 621 is not successfully devoured by the first virtual object 611, but the energy is reduced.

In one embodiment, the energy includes, but is not limited to, a blood volume, a level, an attribute, or performance in another form of the second virtual object, and an energy reduction quantity of the second virtual object is in a positive correlation with the devoured progress. For example, when the devoured progress is 80%, the energy reduction quantity of the rescued second virtual object 621 is a blood volume of 800. When the devoured progress is 90%, an energy reduction quantity of the rescued second virtual object 621 is a blood volume of 900.

For the second virtual object 623, when a devoured progress displayed by a devoured progress bar does not reach 99.9% and a prop energy value displayed by a prop energy bar is less than 0.01%, it indicates that the second virtual object 623 is destroyed by the third virtual object 631 in the different camp, thereby preventing the first virtual object 611 from devouring the second virtual object 623. Therefore, the terminal stops displaying the second virtual object 623 in the virtual environment.

Operation 7. When the second virtual object in the fourth form exists, display the first virtual object executing an absorption action, the absorption action being an action of absorbing the second virtual object in the fourth form, and when the first virtual object completes the absorption action, the first virtual object being in the devouring completion state.

In an example implementation, after the second virtual object is devoured by the devouring prop and is converted into the fourth form, the terminal may control the first virtual object to execute the absorption action, to absorb the second virtual object in the fourth form. Therefore, when the first virtual object completes the absorption action, it indicates that the first virtual object completes devouring, and is in the devouring completion state. Then, when the first virtual object is in the devouring completion state, the terminal displays, in the virtual environment, the first virtual object that obtains a devouring gain.

In one embodiment, in a process of executing the splitting action, a form size of the first virtual object may be represented as a decrease in a body shape. However, in a process of executing the absorption action, a form size of the first virtual object may be represented as an increase in a body shape, and the second virtual object may be represented as an effect of being gradually absorbed.

In one embodiment, the devouring gain includes, but is not limited to, a gain of an attribute, a level, a form, or other performance of the first virtual object.

As shown in FIG. 3, after the second virtual objects 321, 322, and 323 are converted into a liquefied metal layer, the first virtual object 311 executes the absorption action, to absorb the second virtual objects 321, 322, and 323 converted into the liquefied metal layer.

In one embodiment, in the devouring completion state, the form size of the first virtual object 311 changes (for example, the body shape becomes large), and the terminal displays, in the virtual environment, the first virtual object 311 that obtains the devouring gain.

In the foregoing embodiment, when the first virtual object uses the first candidate devouring manner (executes the splitting action), the first virtual object is controlled to split to generate the devouring prop and to transmit the devouring prop to the second virtual object, thereby devouring the second virtual object, and enriching a form in which the first virtual object performs a devouring process. In addition, in the devouring process, the devoured progress is displayed to the player in real time by using the devoured progress bar and the prop energy bar, to facilitate the player controlling the third virtual object to execute the devouring prevention action, thereby optimizing an interaction process between the player and the devouring process, and improving confrontation excitement and fun.

### Second Candidate Devouring Manner

In some embodiments, a first virtual object devours a second virtual object in the second candidate devouring manner. The second candidate devouring manner may alternatively be referred to as “calling devouring”.

When the second candidate devouring manner is used, a devouring process may include the following operations:

Operation 1. Display, in a virtual environment when the first virtual object uses the second candidate devouring manner, the first virtual object executing a calling action, the calling action being an action of calling the second virtual object to move toward the first virtual object.

In an example implementation, when the first virtual object meets a devouring condition, a terminal may control the first virtual object to execute the calling action, to call the second virtual object to move toward the first virtual object, to devour the second virtual object.

In one embodiment, a condition of using the second candidate devouring manner by the first virtual object may be related to an object attribute of the first virtual object (for example, a level of the first virtual object reaches a level threshold), may be related to a virtual prop obtained by the first virtual object (for example, the first virtual object obtains a virtual calling prop), or may be another related condition. This is not limited in this embodiment of this disclosure.

In one embodiment, the calling action is an action of calling the second virtual object to move toward the first virtual object, and may be represented as controlling the first virtual object to roar in the virtual environment, may be represented as controlling the first virtual object to diffuse a gas in the virtual environment, or may be in another representation form. This is not limited in this embodiment of this disclosure.

In one embodiment, one or more second virtual objects may be called once through the calling action, and a quantity of called second virtual objects may be in a positive correlation with an action amplitude of executing the calling action. For example, a higher roaring volume of the first virtual object indicates a larger quantity of called second virtual objects.

In one embodiment, after the first virtual object executes the calling action, a movement speed at which the second virtual object moves toward the first virtual object may be related to an object attribute of the second virtual object (for example, an attack value of the second virtual object), may be related to an object attribute of the first virtual object (for example, an attack value of the first virtual object), or may be related to another factor. This is not limited in this embodiment of this disclosure.

In one embodiment, an object level of the first virtual object is greater than an object level of the second virtual object. In an example implementation, when controlling the first virtual object to execute the calling action, the terminal may first determine whether a second virtual object that conforms to a level condition exists in the virtual environment, so that when a second virtual object whose level is less than that of the first virtual object exists, the terminal controls the second virtual object to move toward the first virtual object.

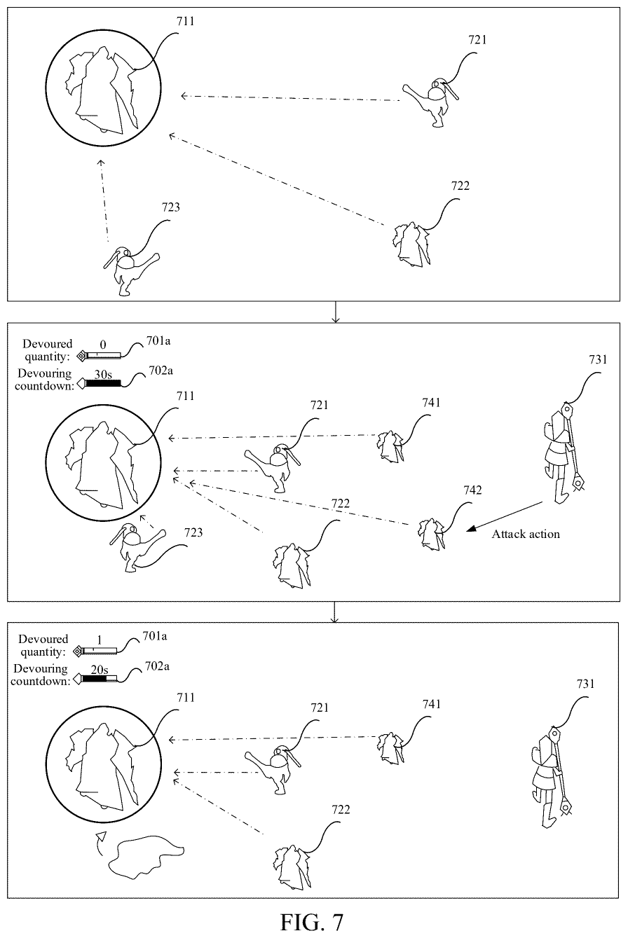

Refer to FIG. 7. FIG. 7 is a schematic diagram of devouring a second virtual object by a first virtual object in a second candidate devouring manner according to an embodiment of this disclosure.

As shown in FIG. 7, a first virtual object 711 devours second virtual objects 721, 722, and 723, and may execute a calling action, to call the second virtual objects 721, 722, and 723 to move toward the first virtual object 711.

For example, the second virtual objects 721, 722, and 723 may move toward the first virtual object 711 through walking, jumping, or running, or in any other manner.

In one embodiment, when a devouring condition corresponding to the second candidate devouring manner is met (for example, a level of the first virtual object 711 reaches a level), a terminal controls the first virtual object 711 to execute the calling action.

In some embodiments, when the first virtual object executes the calling action, the terminal may control to add a quantity of second virtual objects to a virtual environment, so that the first virtual object can devour more second virtual objects, to further increase confrontation difficulty.

As shown in FIG. 7, when the first virtual object 711 executes the calling action, the terminal adds second virtual objects 741 and 742 in the virtual environment, and the second virtual objects 741 and 742 move toward the first virtual object 711.

In some embodiments, the terminal may further determine a quantity of to-be-added second virtual objects based on a battle situation of a third virtual object controlled by a player. For example, when a quantity of second virtual objects that are successfully defeated by the third virtual object reaches a quantity threshold, the terminal may add more second virtual objects to the virtual environment.

Operation 2. Display, when the execution of the calling action is completed, the first virtual object switched to a second form, the first virtual object in the second form not supporting movement or an active attack, and being immune to an attack initiated by another virtual object.

In an example implementation, after the first virtual object executes the calling action, the terminal may determine, based on a distance threshold, whether the second virtual object moves to a periphery of the first virtual object, so that when a distance between a called second virtual object and the first virtual object is less than the distance threshold, the terminal may determine that the execution of the calling action is completed. Further, when the execution of the calling action is completed, the terminal displays, in the virtual environment, the first virtual object switched to the second form.

In one embodiment, the first virtual object in the second form does not support the movement or the active attacks, and is immune to the attack initiated by the other virtual object. The second form is a state that the first virtual object has when the first virtual object devours the second virtual object in the second candidate devouring manner.

In an example implementation, after moving to the periphery of the first virtual object, the second virtual object is converted from an object form into a prop form (for example, a devouring prop), to indicate that the second virtual object is devoured by the first virtual object. For example, after moving to the periphery of the first virtual object, the second virtual object is converted into a virtual liquid, and the first virtual object is also converted into a virtual liquid, so that the first virtual object devours the virtual liquid into which the second virtual object is converted, to form a virtual liquid with a larger volume.

For example, as shown in FIG. 7, the second form may be a form in which the first virtual object 711 is wrapped by the devouring prop (for example, a metal egg), or any form having another display effect.

In one embodiment, the first virtual object 711 in the second form is wrapped by the devouring prop, and therefore cannot perform an operation such as movement, jumping, squatting, switching a prop, or attacking. In addition, the first virtual object 711 in the second form is immune to an attack, that is, any other virtual object cannot attack the first virtual object 711 in the second form.

Operation 3. Display a devoured quantity bar and a devouring countdown, the devoured quantity bar being configured for displaying a devoured quantity of second virtual objects, and the first virtual object being in the devouring completion state when the devouring countdown ends.

In some embodiments, to display, to the player, a quantity of second virtual objects that are devoured after the first virtual object executes the calling action, the terminal may display the devoured quantity bar. The devoured quantity bar is configured for displaying the devouring quantity of devouring the second virtual objects by the first virtual object.

In an example implementation, in consideration of single effectiveness of the calling action, when the first virtual object uses the second candidate devouring manner, the terminal may further set the devouring countdown, so that when the devouring countdown ends, the terminal may control the first virtual object to stop devouring, that is, the first virtual object in the devouring completion state is displayed.

In one embodiment, the devoured quantity bar and the devouring countdown may be displayed in a region, for example, on a peripheral side of the first virtual object or at a top portion of a game interface.

As shown in FIG. 7, in a process in which the first virtual object 711 devours the second virtual objects 721, 722, and 723 in the second candidate devouring manner, the terminal displays a devoured quantity bar 701a and a devouring countdown 702a on the peripheral side of the first virtual object 711.

At one of moments, the devoured quantity bar 701a is displayed as a number 0, representing that the first virtual object 711 does not successfully devour any second virtual object. In this case, the devouring countdown is displayed as 30 s, representing that remaining devouring duration is 30 s.

In some embodiments, in a process in which the first virtual object devours the second virtual object in the second candidate devouring manner, the player may control a third virtual object to attack the second virtual object that is currently devoured, so that when the second virtual object is successfully defeated, the first virtual object may be prevented from devouring the second virtual object, thereby reducing the devouring gain of the first virtual object.

For example, in a process in which the first virtual object 711 devours the second virtual objects 721, 722, 723, 741, and 742 by using the calling action, the third virtual object 731 controlled by the player initiates an attack action against the second virtual object 742, to destroy the second virtual object 742. In this case, a devouring gain corresponding to the second virtual object 742 is not obtained by the first virtual object 711.

As time passes by, a distance between the first virtual object 711 and a plurality of second virtual objects becomes shorter.

Operation 4. When a distance between the second virtual object and the first virtual object is less than a distance threshold, update the devoured quantity displayed by the devoured quantity bar.

In some embodiments, in a process in which the second virtual object moves toward the first virtual object, to display, in real time, the devoured quantity bar corresponding to the first virtual object, the terminal may determine, based on the distance between the first virtual object and the second virtual object, whether the second virtual object is a devoured object, to update the devoured quantity displayed by the devoured quantity bar. In an example implementation, when the distance between the second virtual object and the first virtual object is less than the distance threshold, the terminal updates the devoured quantity displayed by the devoured quantity bar.

The distance threshold may be a preset fixed distance, for example, 0.2 cm.

As shown in FIG. 7, when a distance between the second virtual object 723 and the first virtual object 711 is less than the distance threshold, the terminal cancels displaying the second virtual object 723, and displays a liquefied metal layer at a position of the second virtual object 723, to represent that the second virtual object 723 is successfully devoured by the first virtual object 711. In this case, the devoured quantity bar 701a is displayed as 1, representing that a second virtual object is successfully devoured by the first virtual object, and the devouring countdown 702a is displayed as 20s, representing that remaining devouring duration is 20 s.

When the devouring countdown ends, the first virtual object 711 is in the devouring completion state, and the terminal displays, in the virtual environment, the first virtual object that obtains the devouring gain.

In some embodiments, the devouring gain obtained by the first virtual object is in a positive correlation with the devoured quantity finally displayed by the devoured quantity bar. A larger devoured quantity indicates a larger devouring gain obtained by the first virtual object. For example, if a devoured quantity finally displayed by the devoured quantity bar 701a is 8, the devouring gain obtained by the first virtual object 711 is a blood volume gain of 800 points. If a devoured quantity finally displayed by the devoured quantity bar 701a is 10, the devouring gain obtained by the first virtual object 711 is a blood volume gain of 1000 points.

In some embodiments, when the first virtual object performs devouring in the second candidate devouring manner, the devouring gain may have a basic quantity of points. For example, if the basic quantity of points is 500, after eight second virtual objects are devoured, the devouring gain of the first virtual object is 1300 points.

In one embodiment, the devouring gain includes, but is not limited to, a gain of an attribute, a level, a form, or other performance of the first virtual object.

In some embodiments, the devouring gain is related to a type of the first virtual object. For example, when the first virtual object is a common monster, the devouring gain is a blood volume or a level bonus. When the first virtual object is a boss, the devouring gain is repairing a damaged battle part, or that a new battle part grows (for example, more attack arms grow).

In the foregoing embodiment, when the first virtual object uses the second candidate devouring manner (executes the calling action), the first virtual object is controlled to call the second virtual object, so that the second virtual object moves toward the first virtual object, thereby devouring the second virtual object, and enriching a form in which the first virtual object performs a devouring process. In addition, the devoured quantity is displayed to the player in real time based on the distance between the first virtual object and the second virtual object, to facilitate the player controlling the third virtual object to execute the devouring prevention action, thereby optimizing an interaction process between the player and the devouring process, and improving confrontation excitement and fun.

### Third Candidate Devouring Manner

In some embodiments, a first virtual object devours a second virtual object in the third candidate devouring manner. The third candidate devouring manner may alternatively be referred to as “fusion devouring”.

When the third candidate devouring manner is used, a devouring process may include the following operations:

Operation 1. Display, in the virtual environment when the first virtual object uses the third candidate devouring manner, the first virtual object executing a fusion action, the fusion action being an action of wrapping the second virtual object.

In an example implementation, when the first virtual object meets a devouring condition, a terminal may control the first virtual object to execute the fusion action, that is, control the first virtual object to wrap the second virtual object.

In one embodiment, to display a process of wrapping the second virtual object by the first virtual object to a player, the terminal may convert a display form of the first virtual object, for example, convert the first virtual object into a virtual liquid to wrap the second virtual object, or convert the first virtual object into a virtual gas to wrap the second virtual object, or another display effect that may be used to wrap the second virtual object. This is not limited in this embodiment of this disclosure.

In one embodiment, the fusion action is an action that the first virtual object is converted into a liquefied metal layer to wrap the second virtual object, or an action having another display effect.

In one embodiment, when the first virtual object uses the third candidate devouring manner, a level of the first virtual object is the same as a level of the second virtual object, and an attribute value of the first virtual object is greater than an attribute value of the second virtual object. For example, the levels of the first virtual object and the second virtual object are both level 6, a blood volume of the first virtual object is 3000 points, and a blood volume of the second virtual object is 1000 points.

In an example implementation, when the first virtual object uses the third candidate devouring manner, the terminal first determines whether a second virtual object whose level is the same as that of the first virtual object and whose attribute value is less than that of the first virtual object exists in the virtual environment, so that when the second virtual object that conforms to the condition exists, the terminal controls the first virtual object to execute the fusion action on the second virtual object, to display the second virtual object wrapped by the first virtual object.

In one embodiment, the process of wrapping the second virtual object by the first virtual object may be in a one-to-one correspondence, or may be in a one-to-many correspondence. For example, when the first virtual object is converted into a virtual liquid to wrap the second virtual object, the terminal may convert the first virtual object into two virtual liquids, to respectively wrap two second virtual objects.

Operation 2. Display, when the execution of the function action is completed, the first virtual object switched to a third form, the first virtual object in the third form not supporting movement or an active attack, and being not immune to an attack initiated by another virtual object.

In one embodiment, the third form is a state that the first virtual object has when the first virtual object devours the second virtual object. The first virtual object in the third form does not support the movement or the active attack, and is not immune to the attack initiated by the other virtual object. That is, the first virtual object in the third form may not perform operations such as free walking, running, jumping, squatting, equipping a prop, and launching an attack, and needs to be attacked by the other virtual object.

In one embodiment, when being wrapped by the first virtual object, the second virtual object also cannot perform operations such as free walking, running, jumping, squatting, equipping a prop, and launching an attack, and needs to be attacked by the other virtual object.

In one embodiment, the first virtual object in the third form may be a virtual liquid, a virtual gas, or the like. For example, the third form is a form of a liquefied metal layer wrapping the second virtual object, or a form having another display effect.

In some embodiments, in a process in which the first virtual object is in the third form and devours the second virtual object, to display a devoured progress and an object energy value of the first virtual object to the player, the terminal may also display a devoured progress bar and an object energy bar.

The devoured progress bar is configured for displaying a devoured progress of the second virtual object, and the devoured progress automatically increases with time. For example, when the devouring is performed for 10 s, the devoured progress bar displays that the devoured progress of the second virtual object is 30%. When the devouring is performed for 20 s, the devoured progress bar displays that the devoured progress of the second virtual object is 60%.

The object energy bar is configured for displaying the object energy value of the first virtual object in the third form.

In one embodiment, the object energy value includes a score corresponding to an attribute, a level, a form, or other performance of the first virtual object. For example, the object energy value may be a quantity of blood volume points of the first virtual object in the third form.

In one embodiment, when the object energy value displayed by the object energy bar is greater than an energy threshold, and the devoured progress displayed by the devoured progress bar reaches a progress threshold, the first virtual object is in a devouring completion state.

For example, at a moment, the object energy value displayed by the object energy bar is a blood volume of 20, the energy threshold is a blood volume of 0.1, the devoured progress bar is 100%, and the progress threshold is 99.9%. In this case, the first virtual object is in the devouring completion state, that is, the first virtual object successfully devours the second virtual object.

In one embodiment, the terminal may display the devoured progress bar and the prop energy bar of the devouring prop in a region, for example, on a peripheral side of the first virtual object or at a top portion of a confrontation interface.

In some embodiments, when the player controls a third virtual object to execute a devouring prevention action and the devouring prevention action acts on the first virtual object, the terminal updates the object energy value displayed by the object energy bar, and the devouring prevention action is configured for reducing the object energy value of the first virtual object.

In one embodiment, a reduction quantity of the object energy value is in a positive correlation with a quantity, an attribute, a level, and the like of the third virtual object executing the devouring prevention action. For example, when attack force of the third virtual object is relatively strong, or a level of the third virtual object is relatively high, the reduction quantity of the object energy value is also relatively large.

In one embodiment, the reduction quantity of the object energy value is in a negative correlation with an attribute, a level, and the like of the first virtual object. For example, when a defense capability of the first virtual object is relatively strong, or a level of the first virtual object is relatively high, the reduction quantity of the object energy value is relatively small.

In some embodiments, the second virtual object may be a virtual object belonging to the same camp as or a different camp from the third virtual object. For example, the second virtual object may be a role controlled by the player and belonging to the same camp as the third virtual object. Alternatively, the second virtual object may be a monster controlled by an application program and belonging to a different camp from the third virtual object.

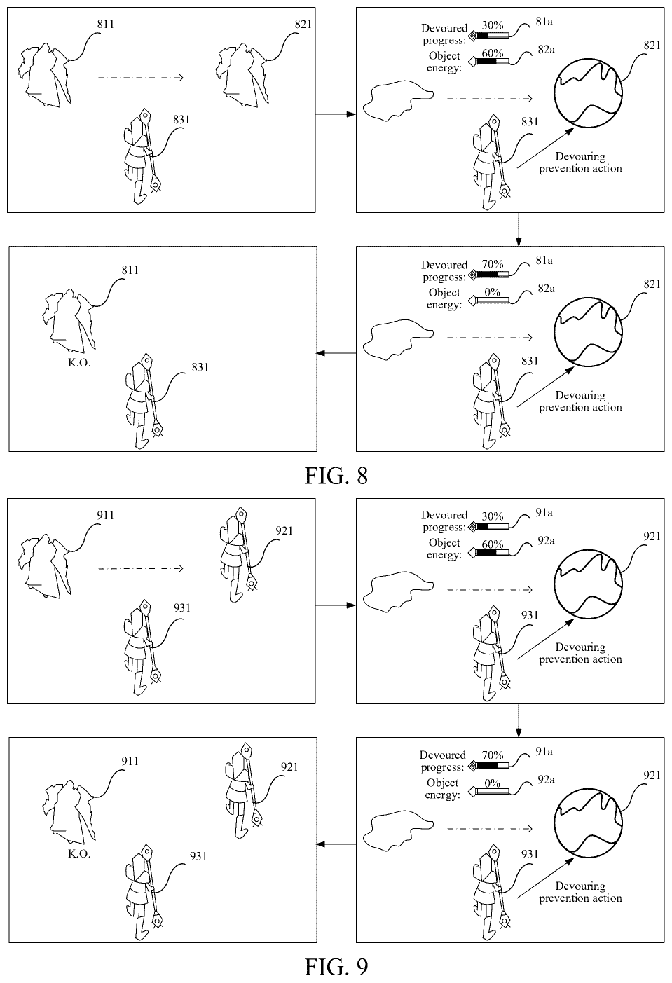

Refer to FIG. 8. FIG. 8 is a schematic diagram of devouring a second virtual object by a first virtual object in a third candidate devouring manner and the second virtual object and a third virtual object belonging to different camps according to an embodiment of this disclosure.

As shown in FIG. 8, a first virtual object 811 devours a second virtual object 821 in the third candidate manner, and is converted into a liquefied metal layer to wrap the second virtual object 821. The second virtual object 821 and the third virtual object 831 belong to different camps, the third virtual object 831 is a virtual object controlled by a player, and the second virtual object 821 is a monster battling with the player.

In a process in which the first virtual object 811 devours the second virtual object 821 in the third candidate manner, the third virtual object 831 executes a devouring prevention action on the first virtual object 811 in a third form, to reduce an object energy value of an object energy bar corresponding to the first virtual object 811.

For example, at a moment, a devoured progress bar 81a and an object energy bar 82a are displayed on a peripheral side of the first virtual object 811 in the third form. The devoured progress bar 81a displays that a devoured progress is 30%, and the object energy bar 82a displays that an object energy value is a blood volume of 60%.

At another moment after the third virtual object 831 executes the devouring prevention action on the first virtual object 811 in the third form, the devoured progress bar 81a displays that an updated devoured progress is 70%, and the object energy bar 82a displays that an updated object energy value is a blood volume of 0%.

In some embodiments, when the object energy value displayed by the object energy bar is less than the energy threshold, the devoured progress displayed by the devoured progress bar does not reach the progress threshold, and the second virtual object and the third virtual object belong to different camps, the terminal displays the first virtual object in the defeated state, and stops displaying the second virtual object.

As shown in FIG. 8, when the object energy value is a blood volume of 0% (less than the energy threshold 0.01%), the devoured progress presented by the devoured progress bar is 70% (that does not reach the progress threshold 99.9%), and the second virtual object 821 and the third virtual object 831 belong to different camps, the terminal displays the first virtual object 811 with an identifier of “K.O.”, to represent that the first virtual object 811 is defeated by the third virtual object 831. Meanwhile, the terminal stops displaying the second virtual object 821, to represent that the second virtual object 821 is also defeated.

Refer to FIG. 9. FIG. 9 is a schematic diagram of devouring a second virtual object by a first virtual object in a third candidate devouring manner and the second virtual object and a third virtual object belonging to the same camp according to an embodiment of this disclosure.

As shown in FIG. 9, a first virtual object 911 devours a second virtual object 921 in the third candidate manner, and is converted into a liquefied metal layer to wrap the second virtual object 921. The second virtual object 921 and a third virtual object 931 belong to the same camp, and the third virtual object 931 and the second virtual object 921 are both virtual objects controlled by a player.

In a process in which the first virtual object 911 devours the second virtual object 921 in the third candidate manner, the third virtual object 931 executes a devouring prevention action on the first virtual object 911 in a third form, to reduce an object energy value of an object energy bar corresponding to the first virtual object 911.

For example, at a moment, a devoured progress bar 91a and an object energy bar 92a are displayed on a peripheral side of the first virtual object 911 in the third form. The devoured progress bar 91a displays that a devoured progress is 30%, and the object energy bar 92a displays that an object energy value is a blood volume of 60%.

At another moment after the third virtual object 931 executes the devouring prevention action on the first virtual object 911 in the third form, the devoured progress bar 91a displays that an updated devoured progress is 70%, and the object energy bar 92a displays that an updated object energy value is a blood volume of 0%.

In some embodiments, the terminal displays the first virtual object in the defeated state, and the second virtual object with reduced energy when the object energy value displayed by the object energy bar is less than the energy threshold, the devoured progress displayed by the devoured progress bar does not reach the progress threshold, and the second virtual object and the third virtual object belong to the same camp.

As shown in FIG. 9, when the object energy value is a blood volume of 0% (less than the energy threshold 0.01%), the devoured progress presented by the devoured progress bar is 70% (that does not reach the progress threshold 99.9%), and the second virtual object 921 and the third virtual object 931 belong to the same camp, the terminal displays the first virtual object 911 with an identifier of “K.O.”, to represent that the first virtual object 911 is defeated by the third virtual object 931. Meanwhile, the terminal displays the second virtual object 921 with reduced energy, to represent that the second virtual object 921 is rescued by the third virtual object 931 but suffers an energy loss.

In some embodiments, an energy reduction quantity of the second virtual object is in a positive correlation with the devoured progress.

For example, when the object energy value displayed by the object energy bar is 0%, and the devoured progress is 70%, the energy reduction quantity of the second virtual object 921 is a blood volume of 700 points. When the object energy value displayed by the object energy bar is 0%, and the devoured progress is 80%, the energy reduction quantity of the second virtual object 921 is a blood volume of 800 points.

After the first virtual object successfully devours the second virtual object, a devouring gain is obtained. The devouring gain may be represented as gains in various forms, including, but not limited to, an attribute increase (such as an increase in a blood volume or an increase in attack force), a level increase, a repair of a damaged battle part, growth of a new battle part, or the like.

In the foregoing embodiment, when the first virtual object uses the third candidate devouring manner (executes the fusion action), the first virtual object is controlled to wrap the second virtual object, to devour the second virtual object, thereby enriching a form in which the first virtual object performs a devouring process. In addition, in the devouring process, the devoured progress bar and the object energy bar of the first virtual object are set, to display the devoured quantity to the player in real time, and to facilitate the player controlling the third virtual object to execute the devouring prevention action, thereby optimizing an interaction process between the player and the devouring process, and improving confrontation excitement and fun.

With reference to the foregoing embodiments, the three different candidate devouring manners are provided, and the different candidate devouring manners have different level requirements or attribute value requirements on the first virtual object and the second virtual object, so that during the confrontation, a devouring manner suitable for the first virtual object may be determined in real time based on the object attribute of the first virtual object, thereby optimizing the devouring process of the first virtual object. In addition, the player may control, in the different devouring manners, the third virtual object to execute different devouring prevention actions, thereby enriching interaction forms between the player and the devouring process, optimizing confrontation performance, and increasing confrontation diversity and a possibility.

In some embodiments, the different candidate devouring manners not only correspond to the different candidate devouring statuses, but also may generate different devouring gains. In one embodiment, the devouring gain obtained by the first virtual object may be related to an object type of the first virtual object, may be related to a devouring manner used by the first virtual object, may be related to an object type of the second virtual object, or may be related to an impact factor in another devouring process. This is not limited in this embodiment of this disclosure.

In one embodiment, a type of the devouring gain is related to a type of the first virtual object and the candidate devouring manner used by the first virtual object.

In some embodiments, when the first virtual object uses the first candidate devouring manner or the second candidate devouring manner, and the first virtual object is of a first type, the terminal displays the first virtual object with an increased attribute in the virtual environment.

In one embodiment, the first type is a virtual object at a non-highest level. For example, the first type may be monsters at various levels other than a boss.

In one embodiment, the attribute includes, but is not limited to, a blood volume, attack force, and defensive power.

In some embodiments, an attribute increase of the first virtual object is in a positive correlation with a quantity of second virtual objects devoured by the first virtual object. For example, when the first virtual object successfully devours five second virtual objects, an increase in attack force of the first virtual object is 500 points. For example, when the first virtual object successfully devours eight second virtual objects, an increase in attack force of the first virtual object is 800 points.

In some embodiments, when the first virtual object uses the first candidate devouring manner or the second candidate devouring manner, and the first virtual object is of a second type, the terminal displays the first virtual object with a changed form in the virtual environment.

In one embodiment, the second type is a virtual object at a highest level. For example, the second type is a monster at a boss level.

In one embodiment, the form change includes a change of a form of a battle part, for example, a repair of a damaged battle part, or growth of a new battle part.

In one embodiment, the form change further includes a change of a size of the form.

For example, after 10 monsters are successfully devoured, three new attack arms of the boss grow, and the new attack arms may strengthen attack force on the third virtual object.

In some embodiments, the terminal displays the first virtual object with an increased level in the virtual environment when the first virtual object uses the third candidate devouring manner.

In one embodiment, a level increase is in a positive correlation with a quantity of second virtual objects. For example, when the first virtual object successfully devours five second virtual objects in the third candidate devouring manner, the level increase is one level. When the first virtual object successfully devours 10 second virtual objects in the third candidate devouring manner, the level increase is 2 levels.

In the foregoing embodiment, the devouring gain obtained by the first virtual object after the devouring is completed is determined in the devouring manner used by the first virtual object and based on the object type of the first virtual object, so that a plurality of different devouring gain effects are generated, thereby improving effect diversity of the devouring process, and further enriching a confrontation effect.

To determine which candidate devouring manner that the first virtual object uses to devour the second virtual object, in some embodiments, when the first virtual object meets the devouring condition, the terminal may determine a target devouring manner from the candidate devouring manners based on an attribute of the first virtual object and an attribute of another virtual object in the virtual environment. Therefore, the first virtual object in a target devouring status is displayed in the virtual environment. The target devouring status is one of at least two candidate devouring statuses, and different candidate devouring statuses correspond to different candidate devouring manners.

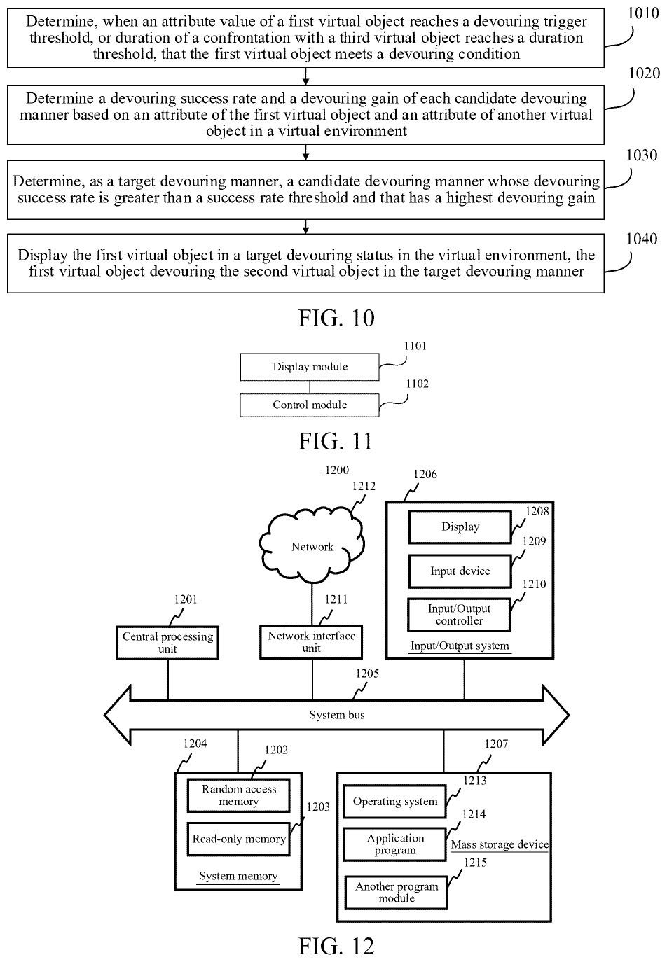

Refer to FIG. 10. FIG. 10 is a flowchart of determining a target devouring manner according to an embodiment of this disclosure. The process may be separately executed by a terminal, may be separately executed by a server, or may be jointly executed by a terminal and a server. The following embodiment is described based on that the terminal executes the process. The process includes the following operations:

Operation 1010. Determine, when an attribute value of a first virtual object reaches a devouring trigger threshold, or duration of a confrontation with a third virtual object reaches a duration threshold, that the first virtual object meets a devouring condition.

The devouring condition is a condition under which the first virtual object initiates devouring to another virtual object. In some embodiments, the devouring condition may be set and determined by the terminal or the server.

In some embodiments, the devouring condition is that the attribute value of the first virtual object reaches the devouring trigger threshold. For example, the devouring condition may be that attack force of a monster reaches 500 points, or that an attack speed reaches 200 points.

In some embodiments, the devouring condition is that confrontation duration between the third virtual object controlled by a player and the first virtual object reaches the duration threshold. For example, the devouring condition may be that the confrontation duration reaches 5 minutes.

In one embodiment, the devouring condition may further be determined based on a battle situation of the virtual object controlled by the player. For example, the devouring condition may be that a quantity of another virtual objects defeated by the third virtual object controlled by the player reaches a quantity threshold.

Operation 1020. Determine a devouring success rate and a devouring gain of each candidate devouring manner based on an attribute of the first virtual object and an attribute of another virtual object in the virtual environment.

In some embodiments, the terminal may obtain a feature such as a level or an attribute of the first virtual object and a feature such as a quantity, an attribute, a type, or a level of the other virtual object in the virtual environment, and determine a plurality of reference battle records in historical battle records. In addition, an average value of devouring success rates and an average value of devouring gains of candidate devouring manners corresponding to the plurality of reference battle records are calculated as a devouring success rate and a devouring gain that correspond to a current candidate devouring manner.

In some embodiments, the terminal may further input the feature such as a level or an attribute of the first virtual object and the feature such as a quantity, an attribute, a type, or a level of the other virtual object in the virtual environment into a prediction model, to determine a devouring success rate and a devouring gain of each candidate devouring manner. The prediction model is a machine learning model obtained through training by using training samples and training labels. The training samples are features of the first virtual object and the other virtual object in the plurality of historical battle records, and the training labels are actual devouring successes and actual devouring gains.

In one embodiment, the success rate is a score value from 0% to 100%.

In one embodiment, the devouring gain includes a sum of a plurality of types of gains, for example, a sum of gains of an attribute, a level, a form, or other performance. Different types of gains may have different weight coefficients. The weight coefficient may be a fixed value set by the terminal. For example, when the devouring gain includes an attribute gain and a level gain, a weight coefficient of the attribute gain is 0.6, and a weight coefficient of the level gain is 0.4, the devouring gain is a blood volume gain of 800 points×0.6+a level gain of 300 points×0.4=600 points.

Operation 1030. Determine, as the target devouring manner, a candidate devouring manner whose devouring success rate is greater than a success rate threshold and that has a highest devouring gain.

For example, devouring success rates of the first candidate devouring manner, the second candidate devouring manner, and the third candidate devouring manner are respectively 80%, 77%, and 50%, and devouring gains are respectively 5600 points, 6300 points, and 4500 points. In this case, when the success rate threshold is 70%, a candidate devouring manner meeting that a devouring success rate is greater than the success rate threshold and having a highest devouring gain is the second candidate devouring manner. Therefore, the terminal determines the second candidate devouring manner as the target devouring manner.

Operation 1040. Display the first virtual object in a target devouring status in the virtual environment, the first virtual object devouring the second virtual object in the target devouring manner.

The target devouring status is a status in which the first virtual object devours the second virtual object in the target devouring manner.

In one embodiment, the target devouring status includes a status of the first virtual object in an aspect such as a form size, an attribute, a level, movement, or an attack. For example, when the target devouring status is a status corresponding to using the first candidate devouring manner, the target devouring status may be a status supporting movement and an active attack.

In some embodiments, the first virtual object devours the second virtual object in the target devouring manner corresponding to the target devouring status. For example, when the target devouring status is a status corresponding to using the first candidate devouring manner, the first virtual object devours the second virtual object in the first candidate devouring manner.

In this embodiment, based on the attribute of the first virtual object and the attribute of the other virtual object in the virtual environment, the devouring success rates and the devouring gains of the candidate devouring manners are determined, and the candidate devouring manner whose devouring success rate is greater than the success rate threshold and that has the highest devouring gain is selected as the target devouring manner, so that the first virtual object may devour the second virtual object by selecting a manner with an easiest success and a highest bonus, thereby further increasing game difficulty, and improving a participation degree of the player.

Refer to FIG. 11. FIG. 11 is a block diagram of a structure of a virtual object control apparatus according to an embodiment of this disclosure. The apparatus includes: a display module 1101, configured to display a first virtual object in a devouring status in a virtual environment when the first virtual object meets a devouring condition, the devouring status being a status in which the first virtual object devours a second virtual object in the virtual environment; the display module 1101 being further configured to display, in the virtual environment when the first virtual object is in a devouring completion state, the first virtual object that obtains a devouring gain; and a control module 1102, configured to control, in response to a control operation on a third virtual object, the third virtual object to attack the first virtual object that obtains the devouring gain.

In one embodiment, the control module 1102 is further configured to control, in the devouring status in response to the control operation on the third virtual object, the third virtual object to execute a devouring prevention action, the devouring prevention action acting on at least one of the first virtual object or the second virtual object.

In one embodiment, the display module 1101 is further configured to: display the first virtual object in a target devouring status in the virtual environment, the target devouring status being one of at least two candidate devouring statuses, and different candidate devouring statuses corresponding to different candidate devouring manners.

In one embodiment, the display module 1101 is further configured to: display, in the virtual environment when the first virtual object uses a first candidate devouring manner, the first virtual object executing a splitting action, the splitting action being an action of transmitting a devouring prop to the second virtual object, and the devouring prop being configured for devouring the second virtual object; and display the first virtual object in a first form when the execution of the split action is completed, the first virtual object in the first form supporting movement and an active attack, and being not immune to an attack initiated by another virtual object; display, in the virtual environment when the first virtual object uses a second candidate devouring manner, the first virtual object executing a calling action, the calling action being an action of calling the second virtual object to move toward the first virtual object; and display, when the execution of the calling action is completed, the first virtual object switched to a second form, the first virtual object in the second form not supporting movement or an active attack, and being immune to an attack initiated by another virtual object; and display, in the virtual environment when the first virtual object uses a third candidate devouring manner, the first virtual object executing a fusion action, the fusion action being an action of wrapping the second virtual object; and display, when the execution of the fusion action is completed, the first virtual object switched to a third form, the first virtual object in the third form not supporting movement or an active attack, and being not immune to an attack initiated by another virtual object.

In one embodiment, the display module 1101 is further configured to: display a devoured progress bar and a prop energy bar of the devouring prop, the devoured progress bar being configured for displaying a devoured progress of the second virtual object, the devoured progress automatically increasing with time, and the prop energy bar being configured for displaying a prop energy value of the devouring prop.

The control module 1102 is further configured to: update, when the devouring prevention action acts on the second virtual object, the prop energy value displayed by the prop energy bar, the devouring prevention action being configured for reducing the prop energy value of the devouring prop; and display, when the prop energy value displayed by the prop energy bar is greater than the energy threshold, and the devoured progress displayed by the devoured progress bar reaches the progress threshold, the second virtual object switched to a fourth form, the fourth form being configured for representing that the second virtual object is devoured.

In one embodiment, the display module 1101 is further configured to: display, when the second virtual object in the fourth form exists, the first virtual object executing an absorption action, the absorption action being an action of absorbing the second virtual object in the fourth form, and when the first virtual object completes the absorption action, the first virtual object being in the devouring completion state.

In one embodiment, the display module 1101 is further configured to: display the second virtual object with reduced energy when the devoured progress displayed by the devoured progress bar does not reach the progress threshold, the prop energy value displayed by the prop energy bar is less than the energy threshold, and the second virtual object and the third virtual object belong to the same camp, an energy reduction quantity of the second virtual object being in a positive correlation with the devoured progress; and stop displaying the second virtual object when the devoured progress displayed by the devoured progress bar does not reach the progress threshold, the prop energy value displayed by the prop energy bar is less than the energy threshold, and the second virtual object and the third virtual object belong to different camps.

In one embodiment, the display module 1101 is further configured to: display a devoured quantity bar and a devouring countdown, the devoured quantity bar being configured for displaying a devoured quantity of second virtual objects, and the first virtual object being in the devouring completion state when the devouring countdown ends; and update, when a distance between the second virtual object and the first virtual object is less than a distance threshold, the devoured quantity displayed by the devoured quantity bar.

In one embodiment, the display module 1101 is further configured to: display a devoured progress bar and an object energy bar, the devoured progress bar being configured for displaying a devoured progress of the second virtual object, the devoured progress automatically increasing with time, the object energy bar being configured for displaying an object energy value of the first virtual object in the third form, and the first virtual object being in the devouring completion state when the object energy value displayed by the object energy bar is greater than an energy threshold and the devoured progress displayed by the devoured progress bar reaches a progress threshold.

In one embodiment, the control module 1102 is further configured to: update, when the devouring prevention action acts on the first virtual object, the object energy value displayed by the object energy bar, the devouring prevention action being configured for reducing the object energy value of the first virtual object.

In one embodiment, the display module 1101 is further configured to: display the first virtual object in a defeated state and the second virtual object with reduced energy when the object energy value displayed by the object energy bar is less than the energy threshold, the devoured progress displayed by the devoured progress bar does not reach the progress threshold, and the second virtual object and the third virtual object belong to a same camp, an energy reduction quantity of the second virtual object being in a positive correlation with the devoured progress; and display the first virtual object in the defeated state and stopping displaying the second virtual object when the object energy value displayed by the object energy bar is less than the energy threshold, the devoured progress displayed by the devoured progress bar does not reach the progress threshold, and the second virtual object and the third virtual object belong to different camps.

In one embodiment, the display module 1101 is further configured to: display the first virtual object with an increased attribute in the virtual environment when the first virtual object uses the first candidate devouring manner or the second candidate devouring manner and the first virtual object is of a first type, an attribute increase of the first virtual object being in a positive correlation with a quantity of second virtual objects devoured by the first virtual object; display, in the virtual environment when the first virtual object uses the first candidate devouring manner or the second candidate devouring manner and the first virtual object is of a second type, the first virtual object whose form changes; and display the first virtual object with an increased level in the virtual environment when the first virtual object uses the third candidate devouring manner.

In one embodiment, a level of the first virtual object is higher than a level of the second virtual object when the first virtual object uses the first candidate devouring manner or the second candidate devouring manner; and when the first virtual object uses the third candidate devouring manner, the level of the first virtual object is the same as the level of the second virtual object, and an attribute value of the first virtual object is greater than an attribute value of the second virtual object.

In one embodiment, the apparatus further includes a devouring determining module, configured to: determine a target devouring manner from the candidate devouring manners based on an attribute of the first virtual object and an attribute of another virtual object in the virtual environment when the first virtual object meets a devouring condition.

In one embodiment, the devouring determining module is configured to: determine a devouring success rate and a devouring gain of each of the candidate devouring manners based on the attribute of the first virtual object and the attribute of the other virtual object in the virtual environment; and determine, as the target devouring manner, a candidate devouring manner whose devouring success rate is greater than a success rate threshold and that has a highest devouring gain.

In one embodiment, the devouring determining module is configured to: determine, when an attribute value of the first virtual object reaches a devouring trigger threshold, or duration of a confrontation with the first virtual object reaches a duration threshold, that the first virtual object meets the devouring condition.

Refer to FIG. 12. FIG. 12 is a schematic diagram of a structure of a terminal according to an embodiment of this disclosure.

The terminal 1200 may perform the virtual object control method in the foregoing embodiments, and the terminal 1200 may run an application program supporting a virtual environment. The terminal 1200 may be a mobile terminal such as a smartphone, a tablet computer, a laptop portable computer, or an in-vehicle terminal, may be a terminal such as a desktop computer or a projection computer, or may be a terminal of another type. A specific type of the terminal 1200 is not limited in this embodiment of this disclosure.

The terminal 1200 includes a central processing unit (CPU) 1201, a system memory 1204 including a random access memory 1202 and a read-only memory 1203, and a system bus 1205 connecting the system memory 1204 and the central processing unit 1201. The terminal 1200 further includes a basic input/output system (I/O system) 1206 configured to help information transmission between components in a computer, and a mass storage device 1207 configured to store an operating system 1213, an application program 1214, and another program module 1215.

The basic input/output system 1206 includes a display 1208 configured to display information and an input device 1209 such as a mouse or a keyboard that is used for inputting information by a user. The display 1208 and the input device 1209 are both connected to the central processing unit 1201 by using an input/output controller 1210 connected to the system bus 1205. The basic input/output system 1206 may further include the input and output controller 1210 to be configured to receive and process inputs from a plurality of other devices such as a keyboard, a mouse, and an electronic stylus. Similarly, the input/output controller 1210 further provides an output to a display screen, a printer, or another type of output device.

The mass storage device 1207 is connected to the central processing unit 1201 by using a mass storage controller (not shown) connected to the system bus 1205. The mass storage device 1207 and an associated computer-readable medium provide non-volatile storage for the terminal 1200. That is, the mass storage device 1207 may include a computer readable medium (not shown), such as a hard disk or a drive.

Without loss of generality, the computer-readable medium may include a computer storage medium and a communication medium. The computer storage medium includes volatile and non-volatile media, and removable and non-removable media implemented by using any method or technology used for storing information such as computer-readable instructions, data structures, program modules, or other data. The computer storage medium includes a random access memory (RAM), a read only memory (ROM), a flash memory or another solid-state storage technology, a compact disc read-only memory (CD-ROM), a digital versatile disc (DVD) or another optical memory, a magnetic cassette, a magnetic tape, a disk storage, or another magnetic storage device. It is noted that the computer storage medium is not limited to the foregoing several types. The system memory 1204 and the mass storage device 1207 may be collectively referred to as a memory.

The memory stores one or more programs. The one or more programs are configured to be executed by one or more central processing units 1201. The one or more programs include instructions for implementing the above methods. The central processing unit 1201 executes the one or more programs to implement the methods provided in the above method embodiments.

According to this embodiment of this disclosure, the terminal 1200 may further be connected to a remote computer on a network for running through a network such as the Internet. For example, the terminal 1200 may be connected to a network 1212 by using a network interface unit 1211 connected to the system bus 1205, or may be connected to another type of network or a remote computer system (not shown) by using the network interface unit 1211.

The memory further includes one or more programs. The one or more programs are stored in the memory and include operations performed by the terminal for performing the method provided in the embodiments of this disclosure.

An embodiment of this disclosure further provides a computer-readable storage medium, having at least one instruction stored thereon, and the at least one instruction being loaded and executed by a processor to implement the method provided in the foregoing embodiments. In one embodiment, the computer-readable storage medium may include a ROM, a RAM, a solid state drive (SSD), an optical disc, or the like. The RAM may include a resistance random access memory (ReRAM) and a dynamic random access memory (DRAM).

An embodiment of this disclosure further provides a computer program product or a computer program, including a computer instruction, and the computer instruction being stored in a computer-readable storage medium; and a processor of a terminal reading the computer instruction from the computer-readable storage medium, and executing the computer instruction, to cause the terminal to perform the method provided in the implementations of the foregoing aspect.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The foregoing disclosure includes some embodiments of this disclosure which are not intended to limit the scope of this disclosure. Other embodiments shall also fall within the scope of this disclosure.

What is claimed is:

1. A method of virtual object control, the method comprising:
displaying a first virtual object in a devouring status in a virtual environment when the first virtual object meets a devouring condition, the devouring status being a status in which the first virtual object performs a devouring on one or more second virtual objects in the virtual environment;
displaying, in the virtual environment when the first virtual object is in a devouring completion state with the devouring being completed, the first virtual object with a devouring gain from the devouring; and
controlling, in response to a control operation on a third virtual object, the third virtual object to attack the first virtual object with the devouring gain.

2. The method according to claim 1, wherein the method further comprises:
controlling, before the devouring is completed and in response to the control operation on the third virtual object, the third virtual object to execute a devouring prevention action on at least one of the first virtual object and the one or more second virtual objects.

3. The method according to claim 1, wherein:
the devouring status is one of a plurality of candidate devouring statuses, the plurality of candidate devouring statuses having respective candidate devouring manners that are different devouring manners.

4. The method according to claim 3, wherein:
the displaying the first virtual object in the devouring status comprises:
displaying, when the first virtual object is of a first candidate devouring status having a first candidate devouring manner, the first virtual object executing a splitting action that transmits at least a devouring prop to a second virtual object in the one or more second virtual objects, the devouring prop devouring the second virtual object; and
displaying the first virtual object in a first form when the splitting action is completed, the first virtual object in the first form being allowed to move in the virtual environment, to perform an active attack to other virtual objects, and to be subject to an attack initiated by another virtual object.

5. The method according to claim 3, wherein:
the displaying the first virtual object in the devouring status comprises:
displaying, when the first virtual object is of a second candidate devouring status having a second candidate devouring manner, the first virtual object executing a calling action that calls the one or more second virtual objects to move toward the first virtual object; and
displaying the first virtual object in a second form when the calling action is completed, the first virtual object in the second form not being allowed to move in the virtual environment, to perform an active attack, or to be subject to an attack initiated by another virtual object.

6. The method according to claim 3, wherein:
the displaying the first virtual object in the devouring status comprises:
displaying, when the first virtual object is of a third candidate devouring status having a third candidate devouring manner, the first virtual object executing a fusion action that wraps at least a second virtual object in the one or more second virtual objects; and
displaying the first virtual object in a third form when the fusion action is completed, the first virtual object in the third form not being allowed to move in the virtual environment or to perform an active attack, and being allowed to be subject to an attack initiated by another virtual object.

7. The method according to claim 4, wherein the method further comprises:
displaying a devoured progress bar for the second virtual object and a prop energy bar of the devouring prop, the devoured progress bar indicating a devoured progress of the second virtual object, and the prop energy bar indicating a prop energy value of the devouring prop.

8. The method according to claim 7, wherein the method further comprises:
controlling, before the devouring is completed and in response to the control operation on the third virtual object, the third virtual object to execute a devouring prevention action on the second virtual object;
updating, the prop energy value of the prop energy bar according to the devouring prevention action, the devouring prevention action reducing the prop energy value of the devouring prop;
displaying, when the prop energy value of the prop energy bar is greater than an energy threshold and the devoured progress of the devoured progress bar reaches a progress threshold, the second virtual object to be in a fourth form, the second virtual object in the fourth form indicating that the second virtual object is devoured; and
displaying, when the second virtual object is in the fourth form, the first virtual object executing an absorption action, the absorption action absorbing the second virtual object in the fourth form, the first virtual object entering the devouring completion state when the absorption action is completed.

9. The method according to claim 8, wherein the method further comprises:
displaying the second virtual object with a reduced energy when:
the devoured progress does not reach the progress threshold,
the prop energy value is less than the energy threshold, and
the second virtual object and the third virtual object belong to a same camp, an energy reduction quantity of the second virtual object being in a positive correlation with the devoured progress; and
stopping displaying the second virtual object when:
the devoured progress does not reach the progress threshold,
the prop energy value is less than the energy threshold, and
the second virtual object and the third virtual object belong to different camps.

10. The method according to claim 5, wherein the method comprises:
displaying a devoured quantity bar and a devouring countdown of the calling action, the devoured quantity bar indicating a devoured quantity in the one or more second virtual objects, and the devouring countdown indicating whether the first virtual object completes the devouring; and
updating, when a distance between a second virtual object in the one or more second virtual objects and the first virtual object is less than a distance threshold, the devoured quantity of the devoured quantity bar.

11. The method according to claim 6, wherein the method comprises:
displaying at least a devoured progress bar of a second virtual object in the one or more second virtual objects and an object energy bar of the first virtual object, the devoured progress bar indicating a devoured progress of the second virtual object, the devoured progress increasing with time, the object energy bar indicating an object energy value of the first virtual object in the third form, and the first virtual object entering the devouring completion state when the object energy value of the object energy bar is greater than an energy threshold and the devoured progress reaches a progress threshold;
controlling, before the devouring is completed and in response to the control operation on the third virtual object, the third virtual object to execute a devouring prevention action on the first virtual object; and
updating, when the devouring prevention action acts on the first virtual object, the object energy value of the object energy bar, the devouring prevention action reducing the object energy value of the first virtual object.

12. The method according to claim 11, wherein the method further comprises:
displaying the first virtual object in a defeated state and the second virtual object with a reduced energy when:
the object energy value of the object energy bar is less than the energy threshold,
the devoured progress of the devoured progress bar does not reach the progress threshold, and
the second virtual object and the third virtual object belong to a same camp, an energy reduction quantity of the second virtual object being in a positive correlation with the devoured progress; or
displaying the first virtual object in the defeated state with the second virtual object not being displayed when:
the object energy value of the object energy bar is less than the energy threshold,
the devoured progress of the devoured progress bar does not reach the progress threshold, and
the second virtual object and the third virtual object belong to different camps.

13. The method according to claim 1, wherein the displaying the first virtual object with the devouring gain comprises at least one of:
displaying the first virtual object with an attribute being increased in the virtual environment, an attribute increase of the first virtual object being in a positive correlation with a quantity in the one or more second virtual objects that are devoured by the first virtual object;
displaying the first virtual object with a form change; and
displaying the first virtual object with an increased level.

14. The method according to claim 1, wherein:
the first virtual object is of a greater level than the one or more second virtual objects; or
the first virtual object is of a same level as the one or more second virtual objects and has a greater attribute value than the one or more second virtual objects.

15. The method according to claim 3, wherein the method further comprises:
determining a target devouring manner from the respective candidate devouring manners based on a first attribute of the first virtual object and a second attribute of a different virtual object from the first virtual object in the virtual environment when the first virtual object meets the devouring condition.

16. The method according to claim 15, wherein the determining the target devouring manner comprises:
determining respective devouring success rates and respective devouring gains of the respective candidate devouring manners based on the first attribute of the first virtual object and the second attribute of the different virtual object in the virtual environment; and
selecting the target devouring manner from the respective candidate devouring manners, the target devouring manner having a devouring success rate greater than a success rate threshold and has a highest devouring gain among the respective candidate devouring manners.

17. The method according to claim 1, wherein the method comprises:
determining, when an attribute value of the first virtual object reaches a devouring trigger threshold or a duration of a confrontation with the first virtual object reaches a duration threshold, that the first virtual object meets the devouring condition.

18. An information processing apparatus for virtual object control, comprising processing circuitry configured to:
display a first virtual object in a devouring status in a virtual environment when the first virtual object meets a devouring condition, the devouring status being a status in which the first virtual object performs a devouring on one or more second virtual objects in the virtual environment;
display, in the virtual environment when the first virtual object is in a devouring completion state with the devouring being completed, the first virtual object with a devouring gain from the devouring; and
control, in response to a control operation on a third virtual object, the third virtual object to attack the first virtual object with the devouring gain.

19. The information processing apparatus according to claim 18, wherein the processing circuitry is configured to:
control, before the devouring is completed and in response to the control operation on the third virtual object, the third virtual object to execute a devouring prevention action on at least one of the first virtual object and the one or more second virtual objects.

20. A non-transitory computer-readable storage medium storing instructions which when executed by at least one processor cause the at least one processor to perform:
displaying a first virtual object in a devouring status in a virtual environment when the first virtual object meets a devouring condition, the devouring status being a status in which the first virtual object performs a devouring on one or more second virtual objects in the virtual environment;
displaying, in the virtual environment when the first virtual object is in a devouring completion state with the devouring being completed, the first virtual object with a devouring gain from the devouring; and
controlling, in response to a control operation on a third virtual object, the third virtual object to attack the first virtual object with the devouring gain.
